(19) United States
(12) Patent Application Publication
(10) Pub. No.: US 2023/0344590 A1
(43) Pub. Date: Oct. 26, 2023

(54) PARTIAL FREQUENCY SOUNDING FOR WIRELESS COMMUNICATION

(71) Applicant: QUALCOMM Incorporated, San Diego, CA (US)

(72) Inventors: Alexandros MANOLAKOS, Escondido, CA (US); Muhammad Sayed Khairy ABDELGHAFFAR, San Jose, CA (US); Runxin WANG, San Diego, CA (US); Pinar SEN, San Diego, CA (US); Yu ZHANG, San Diego, CA (US)

(21) Appl. No.: 18/005,092

(22) PCT Filed: Sep. 24, 2020
(86) PCT No.: PCT/CN2020/117377

§ 371 Date: Jan. 11, 2023

(51) Int. Cl. H04L 5/00; H04W 72/232

(52) U.S. Cl. CPC H04L 5/0051; H04L 5/0012; H04W 72/232

(57) ABSTRACT

Aspects relate to sounding on a subset of available sounding resources. A user equipment (UE) may transmit a sounding reference signal (SRS) on a subset of the frequency resources available for a hop of an SRS hopping sequence. A UE may be configured to use a subset of frequency resources or the UE may autonomously identify this subset. A base station may send a bit map to a UE to indicate the subset of resources to use for a hop. Each bit of the bit map may indicate that the UE is to transmit an SRS on a particular RB or on a particular groups of RBs. The same subset of resources may be designated for each hop or different subsets of resources may be designated for different hops. An indication of the subset of resources may be provided for each hop. The subset of resources may be cycled for different hops.

### TECHNICAL FIELD

The technology discussed below relates generally to wireless communication and, more particularly, to techniques for sounding on a subset of available sounding resources.

### INTRODUCTION

Next-generation wireless communication systems (e.g., 5GS) may include a 5G core network and a 5G radio access network (RAN), such as a New Radio (NR)-RAN. The NR-RAN supports communication via one or more cells. For example, a wireless communication device such as a user equipment (UE) may access a first cell of a first base station (BS) such as a gNB and/or access a second cell of a second base station.

A base station may schedule access to a cell to support access by multiple UEs. For example, a base station may allocate different resources (e.g., time domain and frequency domain resources) for different UEs operating within a cell of the base station.

A UE may transmit reference signals to enable a base station to estimate the channel between the UE and the base station. For example, a UE may generate a sounding reference signal (SRS) based on a known sequence and transmit the SRS on resources allocated by the base station. The base station may then estimate the quality of an uplink channel from the UE based on the SRS. The base station may use this channel estimate to more efficiently allocate resources and/or specify transmission parameters for communication over the channel.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

A base station may allocate a set of frequency resources to be used by a UE for transmitting SRSs. These frequency resources may be wideband or defined according to a frequency hopping pattern. For frequency hopping, at a first hop, the UE may transmit a first SRS on a first set of resource blocks (RBs) that corresponds to a first range of frequencies. Subsequently, at a second hop, the UE may transmit a second SRS on a second set of RBs that correspond to a second range of frequencies that may be different from the first range of frequencies. This frequency hopping process may continue for a third hop, a fourth hop, and so on for all hops defined within a specified SRS bandwidth.

The disclosure relates in some aspects to sounding on a subset of available sounding resources. In some examples, a UE transmits on a subset of the frequency resources available for a given hop (e.g., the first set of RBs referenced above) instead of on all of the available frequency resources for the hop. For example, if four RBs are available for transmission of an SRS for a given hop, a UE may transmit on one RB (e.g., the first RB, the second RB, the third RB, or the fourth RB), on two RBs (e.g., the first and second RBs, the third and fourth RBs, the first and third RBs, the first and fourth RBs, the second and third RBs, or the second and fourth RBs), or on three RBs (e.g., the first, second, and third RBs, the second, third, fourth RBs, the first, second and fourth RBs, or the first, third, and fourth RBs) for that hop.

A UE may be configured to use a subset of frequency resources or the UE may autonomously identify this subset. As an example of the first scenario, a base station may send to the UE an indication of the specific subset of resources to be used. As an example of the second scenario, a UE may identify the specific subset of resources to be used based on a defined algorithm (e.g., an algorithm that would also be used by the base station to determine which resources the UE will use) or in some other manner.

In some examples, the indication of the subset of resources to use sent by a base station may take the form of a bit map. Here, each bit of the bit map may indicate that a UE is to transmit an SRS on a particular RB or on a particular group of RBs. For example, the first bit of the bit map set to a “1” may indicate that the UE is to transmit on the first RB of the RBs available for a particular hop, the second bit of the bit map set to a “1” may indicate that the UE is to transmit on the second RB of the RBs available for a particular hop, and so on. As another example, the first bit of the bit map set to a “1” may indicate that the UE is to transmit on the first and second RBs of the RBs available for a particular hop, the second bit of the bit map set to a “1” may indicate that the UE is to transmit on the third and fourth RBs of the RBs available for a particular hop, and so on. Other groups of RBs and/or other types of bit maps may be used in other examples.

In some examples, the same subset of resources may be designated for each hop. For example, the first hop may transmit an SRS only on the first RB for that hop, the second hop may transmit an SRS only on the first RB for that hop, and so on. Other subsets of RBs may be used in other examples.

In some examples, different subsets of resources may be designated for different hops. For example, the first hop may transmit an SRS only on the first RB for that hop, the second hop may transmit an SRS only on the second RB for that hop, and so on. Other subsets of RBs may be used in other examples. Also, different subsets of resources for different hops may be specified in different ways in different examples.

In some examples, a separate indication of the subset of resources is provided for each hop. For example, a base station may send to a UE a first bit map that specifies the subset for the first hop, a second bit map that specifies the subset for the second hop, and so on.

In some examples, the subset of resources may be cycled for different hops (e.g., the subset may be shifted at each hop). For example, the subset used for the second hop may be a shift (e.g., a shift of one or more RB positions) of the subset used for the first hop, the subset used for the third hop may be a shift of the subset used for the second hop, and so on. In some examples, an additional indication may specify whether a shift is to be applied at a particular hop.

In some examples, a method of wireless communication at a user equipment may include receiving a first configuration, determining from the first configuration a first bandwidth for transmission of a sounding reference signal (SRS), receiving a second configuration, determining from the second configuration at least one second bandwidth associated with at least one frequency hop of the SRS, receiving a third configuration, determining from the third configuration that less than all of a plurality of resource blocks associated with the at least one second bandwidth associated with the at least one frequency hop of the SRS are to be used to transmit the SRS, generating the SRS, and transmitting the SRS to a base station in each frequency hop of the at least one frequency hop via at least one resource block of the plurality of resource blocks. The at least one resource block may be less than all of the plurality of resource blocks associated with the at least one second bandwidth associated with the at least one frequency hop of the SRS. A union of the at least one second bandwidth over a plurality of frequency hops may correspond to the first bandwidth.

In some examples, a user equipment may include a transceiver, a memory, and a processor communicatively coupled to the transceiver and the memory. The processor and the memory may be configured to receive a first configuration via the transceiver, determine from the first configuration a first bandwidth for transmission of a sounding reference signal (SRS), receive a second configuration via the transceiver, determine from the second configuration at least one second bandwidth associated with at least one frequency hop of the SRS, receive a third configuration via the transceiver, determine from the third configuration that less than all of a plurality of resource blocks associated with the at least one second bandwidth associated with the at least one frequency hop of the SRS are to be used to transmit the SRS, generate the SRS, and transmit the SRS via the transceiver to a base station in each frequency hop of the at least one frequency hop via at least one resource block of the plurality of resource blocks. The at least one resource block may be less than all of the plurality of resource blocks associated with the at least one second bandwidth associated with the at least one frequency hop of the SRS. A union of the at least one second bandwidth over a plurality of frequency hops may correspond to the first bandwidth.

In some examples, a user equipment may include means for receiving a first configuration; means for determining from the first configuration a first bandwidth for transmission of a sounding reference signal (SRS), means for receiving a second configuration, means for determining from the second configuration at least one second bandwidth associated with at least one frequency hop of the SRS, means for receiving a third configuration, means for determining from the third configuration that less than all of a plurality of resource blocks associated with the at least one second bandwidth associated with the at least one frequency hop of the SRS are to be used to transmit the SRS, means for generating the SRS, and means for transmitting the SRS to a base station in each frequency hop of the at least one frequency hop via at least one resource block of the plurality of resource blocks. The at least one resource block may be less than all of the plurality of resource blocks associated with the at least one second bandwidth associated with the at least one frequency hop of the SRS. A union of the at least one second bandwidth over a plurality of frequency hops may correspond to the first bandwidth.

In some examples, an article of manufacture for use by a user equipment includes a computer-readable medium having stored therein instructions executable by one or more processors of the user equipment to receive a first configuration, determine from the first configuration a first bandwidth for transmission of a sounding reference signal (SRS), receive a second configuration, determine from the second configuration at least one second bandwidth associated with at least one frequency hop of the SRS, determine from the third configuration that less than all of a plurality of resource blocks associated with the at least one second bandwidth associated with the at least one frequency hop of the SRS are to be used to transmit the SRS, generate the SRS, and transmit the SRS to a base station in each frequency hop of the at least one frequency hop via at least one resource block of the plurality of resource blocks. The at least one resource block may be less than all of the plurality of resource blocks associated with the at least one second bandwidth associated with the at least one frequency hop of the SRS. A union of the at least one second bandwidth over a plurality of frequency hops may correspond to the first bandwidth.

In some examples, receiving the third configuration may include receiving a medium access control-control element (MAC-CE) that includes the third configuration, receiving a downlink control information (DCI) that includes the third configuration, or receiving a radio resource control (RRC) message that includes the third configuration. In some examples, the third configuration may specify a location of the at least one resource block within the plurality of resource blocks associated with the at least one second bandwidth associated with the at least one frequency hop of the SRS. In some examples, the at least one resource block may include at least two resource blocks and the third configuration may specify locations of the at least two resource blocks within the plurality of resource blocks. In some examples, the third configuration may include a bit map, a first bit of the bit map may be mapped to a first subset of the plurality of resource blocks, and a second bit of the bit map may be mapped to a second subset of the plurality of resource blocks.

In some examples, a method of wireless communication at a base station may include generating a first configuration indicative of a first bandwidth for transmission of a sounding reference signal (SRS), transmitting the first configuration to a user equipment, generating a second configuration indicative of at least one second bandwidth associated with at least one frequency hop of the SRS, transmitting the second configuration to the user equipment, generating a third configuration specifying that less than all of a plurality of resource blocks associated with the at least one second bandwidth associated with the at least one frequency hop of the SRS are to be used to transmit the SRS, and transmitting the third configuration to the user equipment. A union of the at least one second bandwidth over a plurality of frequency hops may correspond to the first bandwidth.

In some examples, a base station may include a transceiver, a memory, and a processor communicatively coupled to the transceiver and the memory. The processor and the memory may be configured to generate a first configuration indicative of a first bandwidth for transmission of a sounding reference signal (SRS), transmit the first configuration to a user equipment via the transceiver, generate a second configuration indicative of at least one second bandwidth associated with at least one frequency hop of the SRS, transmit the second configuration to the user equipment via the transceiver, generate a third configuration specifying that less than all of a plurality of resource blocks associated with the at least one second bandwidth associated with the at least one frequency hop of the SRS are to be used to transmit the SRS, and transmit the third configuration to the user equipment via the transceiver. A union of the at least one second bandwidth over a plurality of frequency hops may correspond to the first bandwidth.

In some examples, a base station may include means for generating a first configuration indicative of a first bandwidth for transmission of a sounding reference signal (SRS), means for transmitting the first configuration to a user equipment, means for generating a second configuration indicative of at least one second bandwidth associated with at least one frequency hop of the SRS, means for transmitting the second configuration to the user equipment, means for generating a third configuration specifying that less than all of a plurality of resource blocks associated with the at least one second bandwidth associated with the at least one frequency hop of the SRS are to be used to transmit the SRS, and means for transmitting the third configuration to the user equipment. A union of the at least one second bandwidth over a plurality of frequency hops may correspond to the first bandwidth.

In some examples, an article of manufacture for use by a base station includes a computer-readable medium having stored therein instructions executable by one or more processors of the base station to generate a first configuration indicative of a first bandwidth for transmission of a sounding reference signal (SRS), transmit the first configuration to a user equipment, generate a second configuration indicative of at least one second bandwidth associated with at least one frequency hop of the SRS, transmit the second configuration to the user equipment, generate a third configuration specifying that less than all of a plurality of resource blocks associated with the at least one second bandwidth associated with the at least one frequency hop of the SRS are to be used to transmit the SRS, and transmit the third configuration to the user equipment. A union of the at least one second bandwidth over a plurality of frequency hops may correspond to the first bandwidth.

In some examples, the third configuration may be generated to increase SRS signaling capacity. In some examples, a quantity of bits for the third configuration may be specified to indicate which group of a plurality of groups of resource blocks is to be used to transmit the SRS. In some examples, a quantity of resource blocks may be associated with each bit of a quantity of bits. In some examples, transmitting the third configuration may include transmitting a medium access control-control element (MAC-CE) that includes the third configuration, transmitting a downlink control information (DCI) that includes the third configuration, or transmitting a radio resource control (RRC) message that includes the third configuration. In some examples, the third configuration may specify a location of at least one resource block within the plurality of resource blocks associated with the at least one second bandwidth associated with the at least one frequency hop of the SRS.

In some examples, a method of wireless communication at a user equipment may include receiving at least one first sounding reference signal (SRS) configuration, determining from the at least one first SRS configuration a first bandwidth for a first SRS frequency hop of a plurality of frequency hopped SRS transmissions, receiving a second SRS configuration, determining from the second SRS configuration that less than all of a plurality of resource blocks associated with the first bandwidth for the first SRS frequency hop are to be used to transmit a first SRS, generating the first SRS, and transmitting the first SRS to a base station via at least one first resource block of the plurality of resource blocks associated with the first bandwidth for the first SRS frequency hop. The at least one first resource block may be less than all of the plurality of resource blocks associated with the first bandwidth for the first SRS frequency hop.

In some examples, a user equipment may include a transceiver, a memory, and a processor communicatively coupled to the transceiver and the memory. The processor and the memory may be configured to receive at least one first sounding reference signal (SRS) configuration via the transceiver, determine from the at least one first SRS configuration a first bandwidth for a first SRS frequency hop of a plurality of frequency hopped SRS transmissions, receive a second SRS configuration via the transceiver, determine from the second SRS configuration that less than all of a plurality of resource blocks associated with the first bandwidth for the first SRS frequency hop are to be used to transmit a first SRS, generate the first SRS, and transmit the first SRS via the transceiver to a base station via at least one first resource block of the plurality of resource blocks associated with the first bandwidth for the first SRS frequency hop. The at least one first resource block may be less than all of the plurality of resource blocks associated with the first bandwidth for the first SRS frequency hop.

In some examples, a user equipment may include means for receiving at least one first sounding reference signal (SRS) configuration, means for determining from the at least one first SRS configuration a first bandwidth for a first SRS frequency hop of a plurality of frequency hopped SRS transmissions, means for receiving a second SRS configuration, means for determining from the second SRS configuration that less than all of a plurality of resource blocks associated with the first bandwidth for the first SRS frequency hop are to be used to transmit a first SRS, means for generating the first SRS, and means for transmitting the first SRS to a base station via at least one first resource block of the plurality of resource blocks associated with the first bandwidth for the first SRS frequency hop. The at least one first resource block may be less than all of the plurality of resource blocks associated with the first bandwidth for the first SRS frequency hop.

In some examples, an article of manufacture for use by a user equipment includes a computer-readable medium having stored therein instructions executable by one or more processors of the user equipment to receive at least one first sounding reference signal (SRS) configuration, determine from the at least one first SRS configuration a first bandwidth for a first SRS frequency hop of a plurality of frequency hopped SRS transmissions, receive a second SRS configuration, determine from the second SRS configuration that less than all of a plurality of resource blocks associated with the first bandwidth for the first SRS frequency hop are to be used to transmit a first SRS, generate the first SRS, and transmit the first SRS to a base station via at least one first resource block of the plurality of resource blocks associated with the first bandwidth for the first SRS frequency hop. The at least one first resource block may be less than all of the plurality of resource blocks associated with the first bandwidth for the first SRS frequency hop.

In some examples, a method of wireless communication at a base station may include generating at least one first sounding reference signal (SRS) configuration indicative of a first bandwidth for a first SRS frequency hop of a plurality of frequency hopped SRS transmissions, transmitting the at least one first SRS configuration to a user equipment, generating a second SRS configuration specifying that less than all of a plurality of resource blocks associated with the first bandwidth for the first SRS frequency hop are to be used to transmit a first SRS, and transmitting the second SRS configuration to the user equipment.

In some examples, a base station may include a transceiver, a memory, and a processor communicatively coupled to the transceiver and the memory. The processor and the memory may be configured to generate at least one first sounding reference signal (SRS) configuration indicative of a first bandwidth for a first SRS frequency hop of a plurality of frequency hopped SRS transmissions, transmit the at least one first SRS configuration to a user equipment via the transceiver, generate a second SRS configuration specifying that less than all of a plurality of resource blocks associated with the first bandwidth for the first SRS frequency hop are to be used to transmit a first SRS, and transmit the second SRS configuration to the user equipment via the transceiver.

In some examples, a base station may include means for generating at least one first sounding reference signal (SRS) configuration indicative of a first bandwidth for a first SRS frequency hop of a plurality of frequency hopped SRS transmissions, means for transmitting the at least one first SRS configuration to a user equipment, means for generating a second SRS configuration specifying that less than all of a plurality of resource blocks associated with the first bandwidth for the first SRS frequency hop are to be used to transmit a first SRS, and means for transmitting the second SRS configuration to the user equipment.

In some examples, an article of manufacture for use by a base station includes a computer-readable medium having stored therein instructions executable by one or more processors of the base station to generate at least one first sounding reference signal (SRS) configuration indicative of a first bandwidth for a first SRS frequency hop of a plurality of frequency hopped SRS transmissions, transmit the at least one first SRS configuration to a user equipment, generate a second SRS configuration specifying that less than all of a plurality of resource blocks associated with the first bandwidth for the first SRS frequency hop are to be used to transmit a first SRS, and transmit the second SRS configuration to the user equipment.

These and other aspects of the disclosure will become more fully understood upon a review of the detailed description, which follows. Other aspects, features, and embodiments of the present disclosure will become apparent to those of ordinary skill in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. In similar fashion, while example embodiments may be discussed below as device, system, or method embodiments it should be understood that such example embodiments can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a schematic illustration of an example of wireless resources in an air interface utilizing orthogonal frequency divisional multiplexing (OFDM) according to some aspects.

FIG. 4 is a diagram illustrating an example of a time slot according to some aspects.

FIG. 5 is a conceptual illustration of an example of sounding reference signal (SRS) use cases according to some aspects.

FIG. 6 is a diagram illustrating an example of SRS frequency hopping according to some aspects.

FIG. 7 is a diagram illustrating an example of using a subset of available SRS resources according to some aspects.

FIG. 8 is a diagram illustrating an example of SRS frequency hopping using a subset of available SRS resources according to some aspects.

FIG. 9 is a diagram illustrating an example of bit maps for indicating a subset of available SRS resources according to some aspects.

FIG. 10 is a diagram illustrating an example of using cycling for indicating a subset of available SRS resources according to some aspects.

FIG. 11 is a diagram illustrating another example of SRS frequency hopping using a subset of available SRS resources specified by cycling according to some aspects.

FIG. 12 is a diagram illustrating an example of using selective cycling at different hops for indicating a subset of available SRS resources according to some aspects.

FIG. 13 is a diagram illustrating an example bit map for indicating groups of resource blocks according to some aspects.

FIG. 14 is a signaling diagram illustrating an example of signaling for indicating partial frequency sounding according to some aspects.

FIG. 15 is a signaling diagram illustrating another example of signaling for indicating partial frequency sounding according to some aspects.

FIG. 16 is a signaling diagram illustrating another example of signaling for indicating partial frequency sounding according to some aspects.

FIG. 17 is a block diagram illustrating an example of a hardware implementation for a user equipment employing a processing system according to some aspects.

FIG. 18 is a flow chart of an example process for partial frequency sounding according to some aspects.

FIG. 19 is a flow chart of another example process for partial frequency sounding according to some aspects.

FIG. 20 is a block diagram illustrating an example of a hardware implementation for a base station employing a processing system according to some aspects.

FIG. 21 is a flow chart of an example process for configuring partial frequency sounding according to some aspects.

FIG. 22 is a flow chart of an example process for configuring partial frequency sounding according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

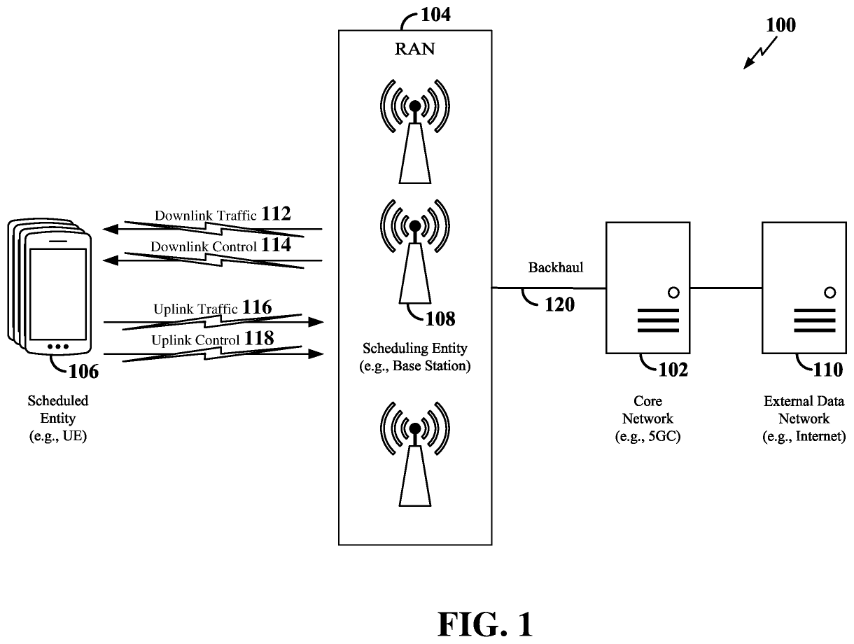

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and at least one scheduled entity 106. The at least one scheduled entity 106 may be referred to as a user equipment (UE) 106 in the discussion that follows. The RAN 104 includes at least one scheduling entity 108. The at least one scheduling entity 108 may be referred to as a base station (BS) 108 in the discussion that follows. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be co-located or non-co-located. The TRPs may communicate on the same carrier frequency or different carrier frequencies within the same frequency band or different frequency bands.

The radio access network 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of Things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

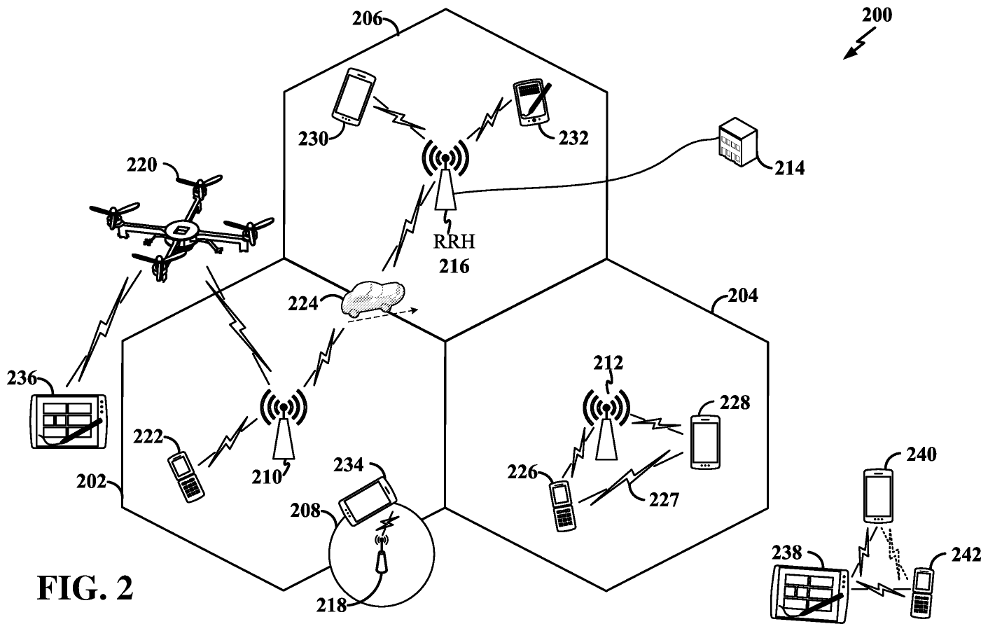

Referring now to FIG. 2, by way of example and without limitation, a schematic illustration of a RAN 200 is provided. In some examples, the RAN 200 may be the same as the RAN 104 described above and illustrated in FIG. 1. The geographic area covered by the RAN 200 may be divided into cellular regions (cells) that can be uniquely identified by a user equipment (UE) based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a third base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

It is to be understood that the radio access network 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

Within the RAN 200, the cells may include UEs that may be in communication with one or more sectors of each cell. Further, each base station 210, 212, 214, and 218 may be configured to provide an access point to a core network (e.g., as illustrated in FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; and UE 234 may be in communication with base station 218. In some examples, the UEs 222, 224, 226, 228, 230, 232, 234, 238, 240, and/or 242 may be the same as the UE/scheduled entity 106 described above and illustrated in FIG. 1.

In some examples, an unmanned aerial vehicle (UAV) 220, which may be a drone or quadcopter, can be a mobile network node and may be configured to function as a UE. For example, the UAV 220 may operate within cell 202 by communicating with base station 210. In some examples, a UAV 220 may be configured to function as a BS. That is, in some examples, a cell may not necessarily be stationary, and the geographic area of the cell may move according to the location of a mobile base station such as a UAV 220.

In the radio access network 200, the ability for a UE to communicate while moving, independent of its location, is referred to as mobility. The various physical channels between the UE and the radio access network are generally set up, maintained, and released under the control of an access and mobility management function (AMF). The AMF (not shown in FIG. 2) may include a security context management function (SCMF) that manages the security context for both the control plane and the user plane functionality, and a security anchor function (SEAF) that performs authentication.

A radio access network 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the radio access network 200. Each of the cells may measure a strength of the pilot signal, and the radio access network (e.g., one or more of the base stations 210 and 214/216 and/or a central node within the core network) may determine a serving cell for the UE 224. As the UE 224 moves through the radio access network 200, the network may continue to monitor the uplink pilot signal transmitted by the UE 224. When the signal strength or quality of the pilot signal measured by a neighboring cell exceeds that of the signal strength or quality measured by the serving cell, the network 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

The air interface in the radio access network 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the radio access network 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancelation technologies. Full-duplex emulation is frequently implemented for wireless links by utilizing frequency division duplex (FDD) or spatial division duplex (SDD). In FDD, transmissions in different directions operate at different carrier frequencies. In SDD, transmissions in different directions on a given channel are separate from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to as sub-band full-duplex (SBFD), also known as flexible duplex.

In a further aspect of the RAN 200, sidelink signals may be used between UEs without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the UE 238 (e.g., functioning as a scheduling entity). Thus, in a wireless communication system with scheduled access to time-frequency resources and having a cellular configuration, a P2P configuration, or a mesh configuration, a scheduling entity and one or more scheduled entities may communicate utilizing the scheduled resources. In some examples, the sidelink signals 227 include sidelink traffic (e.g., a physical sidelink shared channel) and sidelink control (e.g., a physical sidelink control channel).

In some examples, two or more UEs (e.g., UEs 226 and 228) within the coverage area of a serving base station 212 may communicate with both the base station 212 using cellular signals and with each other using direct link signals (e.g., sidelink signals 227) without relaying that communication through the base station. In an example of a V2X network within the coverage area of the base station 212, the base station 212 and/or one or both of the UEs 226 and 228 may function as scheduling entities to schedule sidelink communication between UEs 226 and 228.

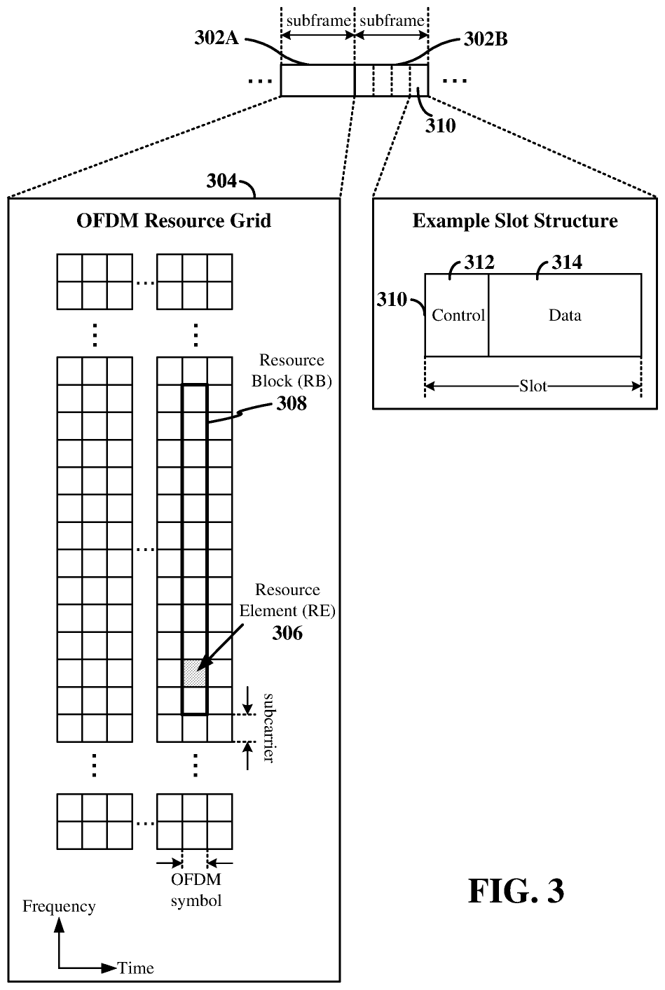

Various aspects of the present disclosure will be described with reference to an OFDM waveform, an example of which is schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an example DL subframe (SF) 302A is illustrated, showing an OFDM resource grid 304. However, as those skilled in the art will readily appreciate, the physical layer (PHY) transmission structure for any particular application may vary from the example described here, depending on any number of factors. Here, time is in the horizontal direction with units of OFDM symbols; and frequency is in the vertical direction with units of subcarriers. 5G NR supports a scalable numerology where different numerologies may be used for different radio frequency spectrums, different bandwidths, and the like. For example, sub-carrier spacings (SCSs) of 15 kHz, 30 kHz, 60 kHz, etc., may be used in different scenarios.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

Scheduling of UEs (e.g., scheduled entities) for downlink, uplink, or sidelink transmissions typically involves scheduling one or more resource elements 306 within one or more sub-bands or bandwidth parts (BWPs). Each BWP may include two or more contiguous or consecutive RBs. Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a base station (e.g., gNB, eNB, RSU, etc.) or may be self-scheduled by a UE implementing D2D sidelink communication.

In this illustration, the RB 308 is shown as occupying less than the entire bandwidth of the subframe 302A, with some subcarriers illustrated above and below the RB 308. In a given implementation, the subframe 302A may have a bandwidth corresponding to any number of one or more RBs 308. Further, in this illustration, the RB 308 is shown as occupying less than the entire duration of the subframe 302A, although this is merely one possible example.

Each 1 ms subframe 302A may consist of one or multiple adjacent slots. In the example shown in FIG. 3, one subframe 302B includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (e.g., one or two OFDM symbols). These mini-slots may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels (e.g., PDCCH), and the data region 314 may carry data channels (e.g., PDSCH or PUSCH). Of course, a slot may contain all DL, all UL, or at least one DL portion and at least one UL portion. The structure illustrated in FIG. 3 is merely an example, and different slot structures may be utilized, and may include one or more of each of the control region(s) and data region(s).

Although not illustrated in FIG. 3, the various REs 306 within a RB 308 may be scheduled to carry one or more physical channels, including control channels, shared channels, data channels, etc. Other REs 306 within the RB 308 may also carry pilots or reference signals, including but not limited to a demodulation reference signal (DMRS), a control reference signal (CRS), or a sounding reference signal (SRS). These pilots or reference signals may provide for a receiving device to perform channel estimation of the corresponding channel, which may enable coherent demodulation/detection of the control and/or data channels within the RB 308.

In some examples, a slot 310 may be utilized for broadcast or unicast communication. In V2X or D2D networks, a broadcast communication may refer to a point-to-multipoint transmission by a one device (e.g., a vehicle, base station (e.g., RSU, gNB, eNB, etc.), UE, or other similar device) to other devices. A unicast communication may refer to a point-to-point transmission by a one device to a single other device.

In an example, the control region 312 of the slot 310 may include a physical downlink control channel (PDCCH) including downlink control information (DCI) transmitted by a base station (e.g., gNB, eNB, RSU, etc.) towards one or more of a set of UEs, which may include one or more sidelink devices (e.g., V2X/D2D devices). In some examples, the DCI may include synchronization information to synchronize communication by a plurality of sidelink devices on the sidelink channel. In addition, the DCI may include scheduling information indicating one or more resource blocks within the control region 312 and/or data region 314 allocated to sidelink devices for sidelink communication. For example, the control region 312 of the slot may further include control information transmitted by sidelink devices over the sidelink channel, while the data region 314 of the slot 310 may include data transmitted by sidelink devices over the sidelink channel. In some examples, the control information may be transmitted within a physical sidelink control channel (PSCCH), while the data may be transmitted within a physical sidelink shared channel (PSSCH).

In a DL transmission (e.g., over the Uu interface), the transmitting device (e.g., the scheduling entity) may allocate one or more REs 306 (e.g., within a control region 312) to carry DL control information including one or more DL control channels, such as a PBCH; and/or a physical downlink control channel (PDCCH), etc., to one or more scheduled entities. The transmitting device may further allocate one or more REs 306 to carry other DL signals, such as a DMRS; a phase-tracking reference signal (PT-RS); a channel state information-reference signal (CSI-RS); a primary synchronization signal (PSS); and a secondary synchronization signal (SSS).

The PDCCH may carry downlink control information (DCI) including but not limited to power control commands, scheduling information, a grant, and/or an assignment of REs for DL and UL transmissions. The PHY carries HARQ feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission confirmed, an ACK may be transmitted, whereas if not confirmed, a NACK may be transmitted. In response to a NACK, the transmitting device may send a HARQ retransmission, which may implement chase combining, incremental redundancy, etc.

In an UL transmission (e.g., over the Uu interface), the transmitting device (e.g., the scheduled entity) may utilize one or more REs 306 to carry UL control information including one or more UL control channels, such as a physical uplink control channel (PUCCH), to the scheduling entity. UL control information may include a variety of packet types and categories, including pilots, reference signals, and information configured to enable or assist in decoding uplink data transmissions. For example, the UL control information may include a DMRS or SRS. In some examples, the control information may include a scheduling request (SR), i.e., request for the scheduling entity to schedule uplink transmissions. Here, in response to the SR transmitted on the control channel, the scheduling entity may transmit downlink control information that may schedule resources for uplink packet transmissions. UL control information may also include HARQ feedback, channel state feedback (CSF), or any other suitable UL control information.

In addition to control information, one or more REs 306 (e.g., within the data region 314) may be allocated for user data or traffic data. Such traffic may be carried on one or more traffic channels, such as, for a DL transmission, a PDSCH; or for an UL transmission, a physical uplink shared channel (PUSCH). In some examples, one or more REs 306 within the data region 314 may be configured to carry SIBs (e.g., SIB1), carrying system information that may enable access to a given cell.

The physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-3 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

A UE may transmit sounding reference signals (SRSs) to a base station over a particular bandwidth to enable the base station to estimate the uplink channel over that bandwidth. In this way, the base station may better schedule uplink transmissions from the UE (e.g., the base station may select which frequency band the UE is to use for an uplink transmission).

A base station may allocate frequency resources to be used by a UE for transmitting SRSs. For example, a base station may transmit SRS configuration information to a UE that specifies the SRS resources and other parameters to be used by a UE to transmit SRSs.

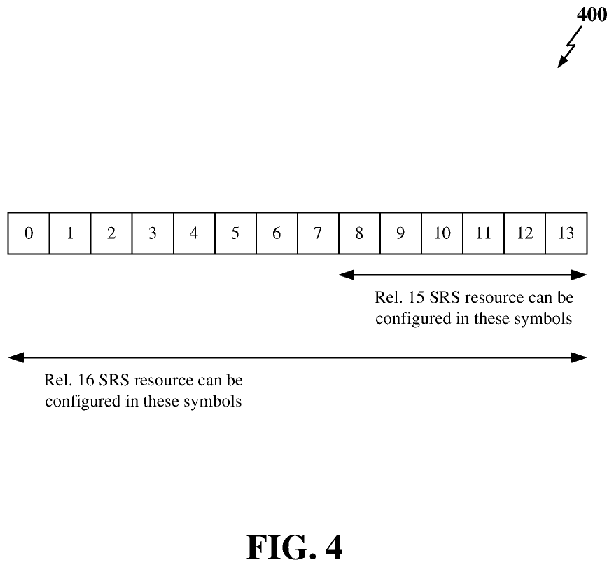

NR supports NR SRS resources that span adjacent symbols. In NR Rel 15, an SRS is transmitted in the last 6 symbols of a timeslot as shown in the representative timeslot 400 of FIG. 4. Here, the SRS resources may span 1, 2, or 4 adjacent symbols. In this case, an SRS is transmitted after the PUSCH in that slot. In NR Rel. 16, an SRS may transmitted in any of the symbols of a timeslot as shown in the representative timeslot 400 of FIG. 4. Here, the SRS resources may span up to 12 adjacent symbols.

A base station may configure one or more SRS resource sets (e.g., two SRS resource sets) for a UE. An SRS resource set specifies a set of SRS resources to be used by a UE to transmit an SRS. In some examples, a UE may use different resource sets for transmitting at different symbols. A defined number of antenna ports may be used for each SRS resource. In some examples, a given antenna port may correspond to a particular set of antenna elements and/or other beamforming parameters (e.g., signal phases and/or amplitudes). In some examples, all ports of an SRS resource are sounded in each symbol of a timeslot.

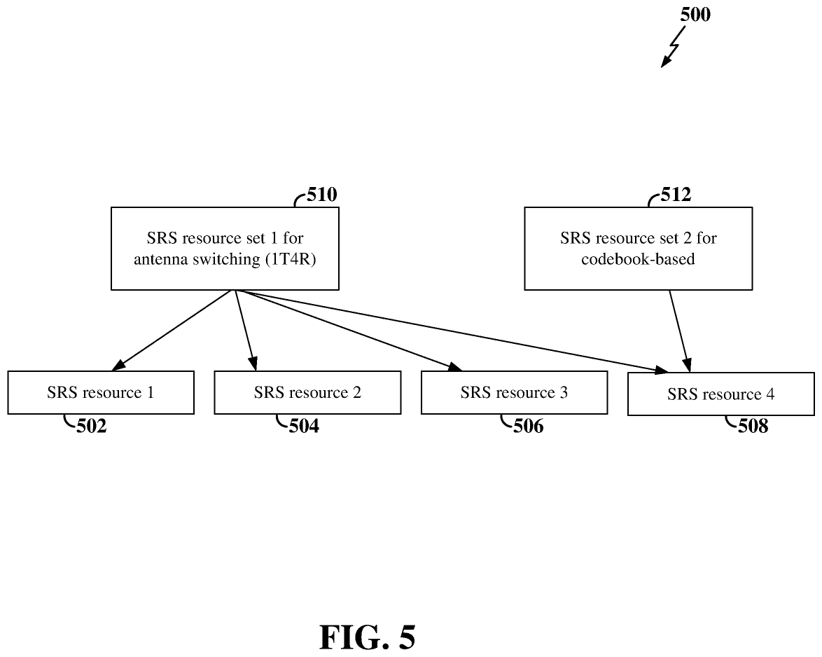

The diagram 500 of FIG. 5 illustrates an example of four SRS resources: an SRS resource 1 502, an SRS resource 2 504, an SRS resource 3 506, and an SRS resource 4 508. An SRS resource set may be transmitted aperiodically (e.g., a base station may indicate the SRS resource set(s) to be used by a UE in a DCI), semi-persistently, or periodically.

A UE may be configured with multiple SRS resources, which may be grouped in a SRS resource set depending on a use case. Examples of SRS use cases include antenna switching-based sounding, codebook-based sounding, non-codebook based sounding, beam management sounding, and positioning sounding. For example, FIG. 5 illustrates a scenario where the SRS resource 1 502, the SRS resource 2 504, the SRS resource 3 506, and the SRS resource 4 508 are grouped for antenna switching-based sounding 510. In addition, in the example of FIG. 5, the SRS resource 4 508 is also designated for codebook-based sounding 512.

In some examples, SRS transmissions may be wideband transmissions (e.g., an SRS is transmitted over the entire allocated SRS bandwidth). In some examples, SRS transmissions may be sub-band transmissions (e.g., an SRS is transmitted over one or more sub-bands of the allocated SRS bandwidth). In some examples, SRS bandwidth is defined as a multiple of four PRBs.

In some examples, a UE may use frequency hopping to transmit SRSs over different sub-bands. A base station may configure a hopping scheme for each SRS resource set for a UE. For frequency hopping, the SRS bandwidth may refer to the total bandwidth that will be hopped across all hops (e.g., during a slot, a set of slots, a set of symbols, or some other time span).

Equation 1 is an example of an algorithm for specifying an SRS frequency hopping sequence. Here, if the bandwidth of a hop is less than the total SRS bandwidth (bₕₒₚ<B_{SRS}), frequency hopping is enabled and the frequency position indices n_{b} (e.g., starting RB locations for each hop) are defined by:

$$\begin{matrix}{n}_{b} = \{ \frac{⌊ 4 {n}_{R R C} / {m}_{SRS , b} ⌋ {mod N}_{b}}{\{ {F}_{b} ( {n}_{S R S} ) + ⌊ 4 {n}_{R R C} / {m}_{SRS , b} ⌋ \} mod {N}_{b}} & \begin{matrix}b \leq {b}_{h o p} \\ otherwise\end{matrix}\end{matrix} \qquad EQUATION 1$$

$$where {N}_{b} is defined ( e . g . , by the 3 GGP standard ) ,$$

$${F}_{b} ( {n}_{S R S} ) = \{ \begin{matrix}( {N}_{b} / 2 ) ⌊ \frac{{n}_{S R S} {mod Π}_{{b}^{′} = {b}_{h o p}}^{b} {N}_{{b}^{′}}}{{Π}_{{b}^{′} = {b}_{h o p}}^{b - 1} {N}_{{b}^{′}}} ⌋ + ⌊ \frac{{n}_{S R S} {mod Π}_{{b}^{′} = {b}_{h o p}}^{b} {N}_{{b}^{′}}}{2 {Π}_{{b}^{′} = {b}_{h o p}}^{b - 1} {N}_{{b}^{′}}} ⌋ & if {N}_{b} even \\ ⌊ {N}_{b} / 2 ⌋ ⌊ {n}_{S R S} / {Π}_{{b}^{′} = {b}_{h o p}}^{b - 1} {N}_{{b}^{′}} ⌋ & if {N}_{b} odd\end{matrix}$$

The parameter m_{SRS,b} corresponds to the SRS hopping bandwidth (e.g., the bandwidth of each hop). The parameter N_{b} is the index of the RBs (e.g., an index to the starting point for an SRS transmission at each hop) that are going to be used for SRS transmission. The parameter N_{bhop}=1 regardless of the value of N_{b} in some examples. The quantity n_{SRS} counts the number of SRS transmissions (e.g., the number of symbols). The parameter n_{RRC} is number of hops. For the case of an SRS resource configured as aperiodic by a higher-layer parameter resourceType, the number of SRS transmission is given by n_{SRS}=└1′/R┘ within the slot in which the N_{symb}^{SRS} symbol SRS resource is transmitted. The quantity R≤N_{sym}^{SRS} is the repetition factor given by a field repetitionFactor contained in a higher-layer parameter resourceMapping. For the case of an SRS resource configured as periodic or semi-persistent by a higher-layer parameter resourceType, the SRS counter is given by Equation 2 for slots that satisfy (Nₛₗₒₜ^{frame,μ}n_{f}=n_{s,f}^{μ}−T_{offset})mod T_{SRS}=0, where the periodicity T_{SRS} in slots of slot offset T_{offset} may be defined (e.g., by the 3GGP standard).

$${n}_{SRS} = ( \frac{{N}_{slot}^{frame , μ} {n}_{f} = {n}_{s , f}^{μ} {T}_{offset}}{{T}_{S R S}} ) \times ( \frac{{N}_{s y m b}^{S R S}}{R} ) + ⌊ \frac{{l}^{′}}{R} ⌋ \qquad EQUATION 2$$

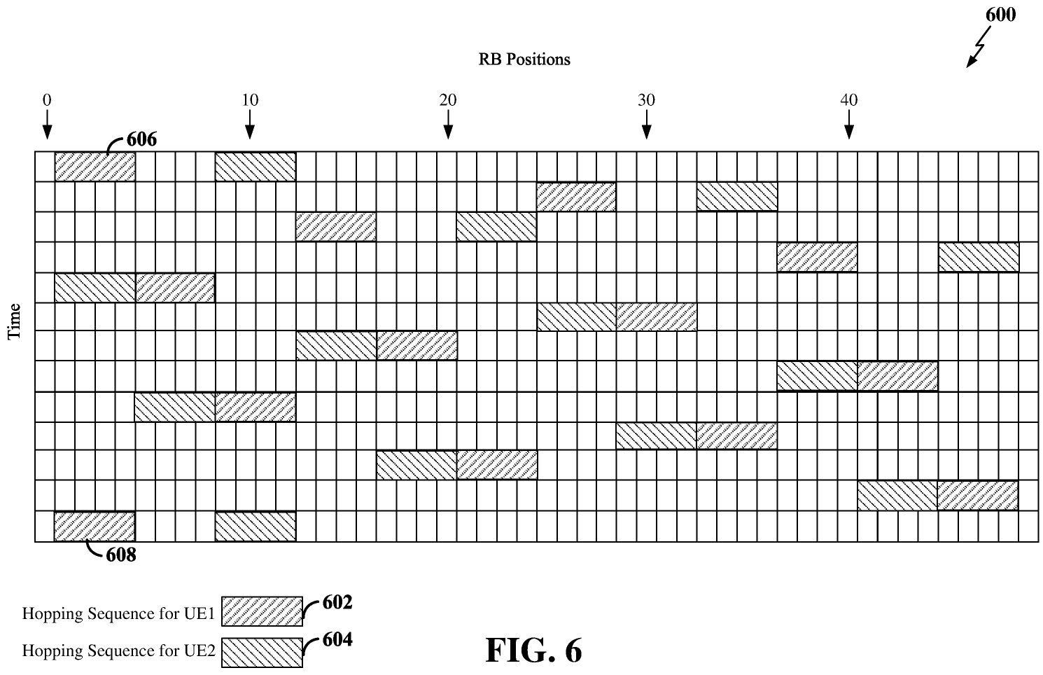

FIG. 6 illustrates an example of a frequency hopping pattern 600 within which a first hopping sequence 602 for a first UE (UE1) and a second hopping sequence 604 for a second UE (UE2) are defined. For example, a first hop for the first hopping sequence 602 is indicated by a first set of RBs 606, a second hop for the first hopping sequence 602 is indicated by a second set of RBs 608, and so on. In FIG. 6, the x-axis represents frequency (e.g., RBs) and the y-axis represents time (e.g., symbols, slots, etc.).

If frequency hopping of the SRS is enabled, then the srs-HoppingBandwidth (e.g., m_{SRS,b}) is smaller than the srs-Bandwidth (e.g., B_{SRS}). If the srs-Bandwidth=bw3 and the srs-HoppingBandwidth=hbw0 as defined by the 3GPP standard, then the SRS bandwidth=48 PRBs and the SRS Hopping Bandwidth=4 PRBs. For the first UE (UE1) and the second UE (UE2), the parameter transmissionComb=0, and the freqDomainPosition=0 for UE1 and the freqDomainPosition=2 for UE2. The parameter transmissionComb controls which sub-carriers are used for transmitting the SRS within each RB. Since the srs-Bandwidth is set to 3, both of the UEs use four RBs in every subframe for SRS transmission in this example. Here, the UE1 is transmitting SRS over the entire bandwidth of interest (SRS Bandwidth=48 PRBs) but not in single shot. That is, the sum of the bandwidths for each hop (e.g., m_{SRS,b}) over the total number of hops (e.g., n_{RRC}) corresponds to the total SRS bandwidth (e.g., B_{SRS}). The UE2 operates in a similar manner.

A base station may send at least one SRS configuration to a UE that specifies, for example, the SRS bandwidth and SRS hoping bandwidth to be used by the UE for each configured SRS resource set. For example, a set of bandwidth configurations (C_{SRS}) may be defined that specifies, for different values of C_{SRS}, different m_{SRS,b} values for different RB groupings (e.g., 4 RBs per hop, 8 RBs per hop, etc.). Thus, a base station may send an SRS bandwidth configuration (e.g., a particular C_{SRS} value) to a UE to configure SRS transmissions by the UE.

The disclosure relates in some aspects to partial frequency sounding. For example, a base station may configure a UE to use only a subset of the RBs that are available at each hop to transmit an SRS. In some aspects, partial frequency sounding may provide more flexibility for SRS frequency resources allocation to allow SRS transmissions for additional UEs within legacy SRS frequency resources. For example, by using partial frequency sounding, the SRS capacity may be increased without affecting legacy UEs that are using SRS resources.

For partial frequency sounding, the bandwidth a UE uses for transmitting an SRS at each hop may be based on three parameters configured by a base station in some examples. The SRS bandwidth (e.g., B_{SRS}) defines the total bandwidth to be hopped, the SRS hopping bandwidth (e.g., m_{SRS,b}) specifies the bandwidth available for each hop, and a frequency selective indication (e.g., a partial frequency sounding indication) identifies a subset of the SRS hopping bandwidth that will actually be used to transmit an SRS at a given hop.

The disclosure relates in some aspects to signaling a frequency selective indication that identifies the SRS resources to be used by a UE. In some examples, a base station may transmit such an indication to a UE via unicast signaling.

In some examples, the indication may specify to the UE the partial frequency resources per the SRS resources or per hop. For hopping, the UE will transmit an SRS on the indicated sub-hop frequency resources. In some examples, a sub-hop frequency resource may be one or more RBs of a set of RBs allocated for an SRS hop.

In some examples, a sub-hop is fixed across all hops. For example, in each hop, a UE may transmit an SRS in the first RB for that hop. In this case, the indication may be a local RB index within each hop (e.g., a bit map corresponding to the first RB, the second RB, etc.). Other sub-hops (e.g., RBs) may be used in other examples. This approach may be advantageous, for example, for scenarios where a uniform distribution of the SRSs across frequencies is desirable.

In some examples, cycling of the sub-hop may be employed. Here, the sub-hop used to transmit SRS in one hop may be shifted for the next hop. For example, for a first hop, a UE may transmit an SRS in the first RB for that hop, for a second hop, the UE may transmit an SRS in the second RB for that hop, and so on. Other forms of cycling (e.g., different ways to shift for each hop) may be used in other examples. In some examples, a base station may configure a UE to cycle in a particular manner (e.g., shift by 1 bit each hop, shift by two bits each hop, etc.). In some examples, a UE may be preconfigured to cycle in a particular manner. This approach may be advantageous, for example, for scenarios where interference mitigation is needed for legacy UE sounding across the full hop bandwidth.

A UE may be configured to use different types of hopping (e.g., a fixed RB for each hop, cycling of the RB position, etc.) in different examples. In some examples, a UE may be preconfigured to use one type of hopping. In some examples, a base station may signal the UE to use a particular type of hopping.

The disclosure relates in some aspects to different signaling options for sending a partial frequency sounding indication. In some examples, a base station transmits the indication via a MAC-CE. In some examples, a base station transmits the indication via a dynamic DCI. In some examples, a base station transmits the indication via a DCI and an RRC message. In some examples, the type of partial frequency sounding used (e.g., static or cyclic) may depend on the signaling used. In some examples, a UE may be configured to use a particular type of partial frequency sounding (e.g., static or cyclic).

In some examples, a MAC-CE indicates the bit map of the frequency resources. One bit may map to a group of RBs (e.g., 4 PRBs). This grouping may be used irrespective of whether hopping is enabled or not. The number of bits can be configurable. The number of RBs that each bit is mapped to also may be configurable.

For optional sub-hop cycling, multiple bit maps may be indicated (e.g., one bit map per hop). Alternatively, a single bit map may be used for the first hop in combination with cycling (e.g., bits rotation) for other hops.

In some examples, cycling may be enabled or disabled for each per hop. For example, given an enable/disable sequence 0011, if the bit map is 1000 for the first hop, cycling is not done for the second hop (sequence bit=0). Thus, the bit map for the second hop is 1000. Cycling is not done for the third hop (sequence bit=0). Thus, the bit map for the third hop is 1000. Cycling is done for the fourth hop (sequence bit=1). Thus, the bit map for the fourth hop is 0100. Cycling is done for the fifth hop (sequence bit=1). Thus, the bit map for the fifth hop is 0010.

In some examples, a bit map may be used to activate/deactivate transmission of an SRS on a per hop basis. For example, a base station may transmit a bit map indication in the MAC-CE (e.g., an outer loop on/off hop indication).

The above techniques may apply to periodic, semi-persistent, and aperiodic SRS resources for all SRS use cases (e.g., SRS for positioning, etc.).

In some examples, a DCI may implicitly or explicitly indicate the frequency resources of the SRS. For example, a frequency domain resource allocation (FDRA)-like approach or a bit map may be used to indicate the RBs or RB group to be used for each SRS transmission. In some examples, such an indication may identify the starting RB position and the number of RBs to be used for each hop. In some examples, DCI format 0_1 may be used in scenarios where the DCI does not schedule a data transmission. In this case, one or more bits of the DCI (e.g., the FDRA) may be repurposed to indicate the frequency resource. Here, the transmit power control (TPC) may be updated accordingly.

In some examples, an SRS may implicitly indicate partial frequency sounding. An SRS request field takes a value [00, 01, 10, 11]. Each SRS resource set is associated with a TriggerList which also takes a value [00, 01, 10, 11]. In some examples, an association of these values may be made with either full frequency sounding or partial frequency sounding. For example, an SRS resource may be associated with a TriggerList of 01 and 10. The TriggerList=01 may be associated with partial frequency sounding, whereas the TriggerList=10 may be associated with full sounding. Thus, all SRS resources that are triggered by TriggerList=00 may be use partial frequency sounding. In some examples, another indication (e.g., sent to the UE via an RRC configuration) may indicate the specific RBs to be used when partial frequency sounding is enabled.

The disclosure relates in some aspects to different techniques for scaling the SRS resources and SRS resource sets triggered by the DCI. In some examples, the FDRA (or some other set of bits) includes a bit mask for all triggered SRS resource(s)/sets. In some examples, the FDRA along with other fields are divided into blocks, where each block specifies the frequency resources for a corresponding SRS resource set. For example, for a 20 bit FDRA, and a DCI triggering one set with 4 resources, the 20 bits may be split into 5-bit blocks. The i-th block controls the sub-hop that is being sounded in the i-th resource of the triggered set.

In some examples, partial frequency sounding may be indicated by a single bit in a DCI or a RRC configuration flag. When enabled, SRS resources will be partially frequency sounded. The sub-hop index may be selected in different ways in different examples. In some examples, a UE may randomly select the index (e.g., based on a floor (scrambling ID/N_subhops)). In this case, the index may be fixed across all hops. As another example, a UE may select the index based on a round robin scheme across hops and/or using cycling.

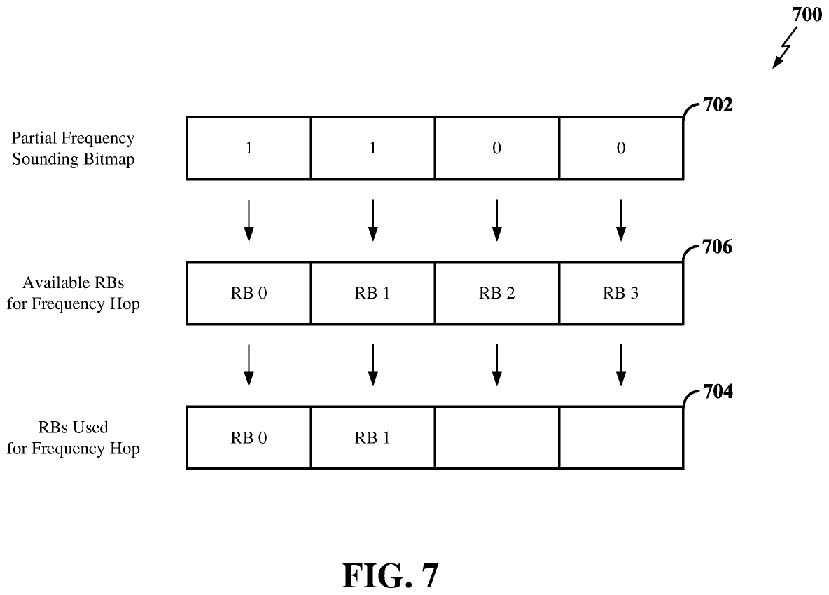

FIG. 7 is a diagram illustrating an example of using a subset of available SRS resources according to some aspects. Here, a bit map 702 identifies the subset of RB locations 704 to use for an SRS transmission for a hop of a set of available RBs 706. In this case, the first bit of the bit map 702 maps to the first RB (RB0) allocated for a hop, the second bit of the bit map 702 maps to the second RB (RB1) allocated for a hop, and so on. Given the value [1100] for the bit map 702, for a given hop, the UE will transmit the SRS on the first RB (RB0) and the second RB (RB1).

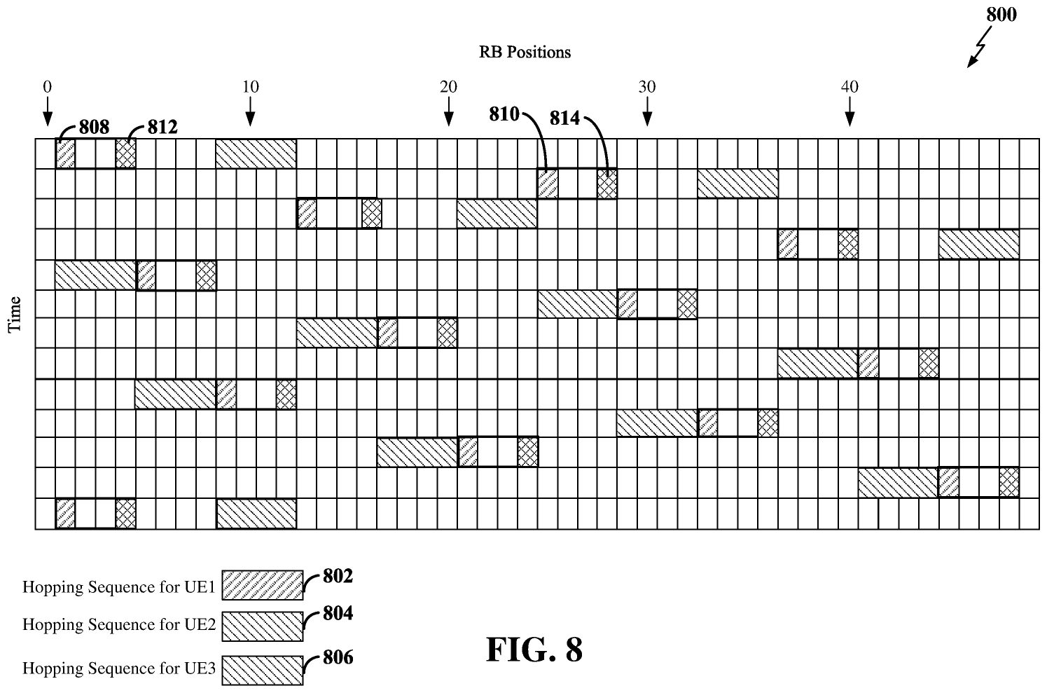

FIG. 8 is a diagram illustrating an example of SRS frequency hopping using a subset of available SRS resources according to some aspects. Here, a frequency hopping pattern 800 includes a first hopping sequence 802 for a first UE (UE1), a second hopping sequence 804 for a second UE (UE2), and a third hopping sequence 806 for a third UE (UE3). In some examples, the first UE may be a legacy UE and the second UE and the third UE may support partial frequency sounding. As indicated for example by sub-hops 808 and 810 for the second UE, the second UE uses one sub-hop (RB) to transmit an SRS at each hop. In addition, all of the hops use the same sub-hop (the first RB allocated for the hop). Similarly, as indicated for example by sub-hops 812 and 814 for the third UE, the third UE uses one sub-hop (RB) to transmit an SRS at each hop. In addition, all of the hops use the same sub-hop (the fourth RB allocated for the hop).

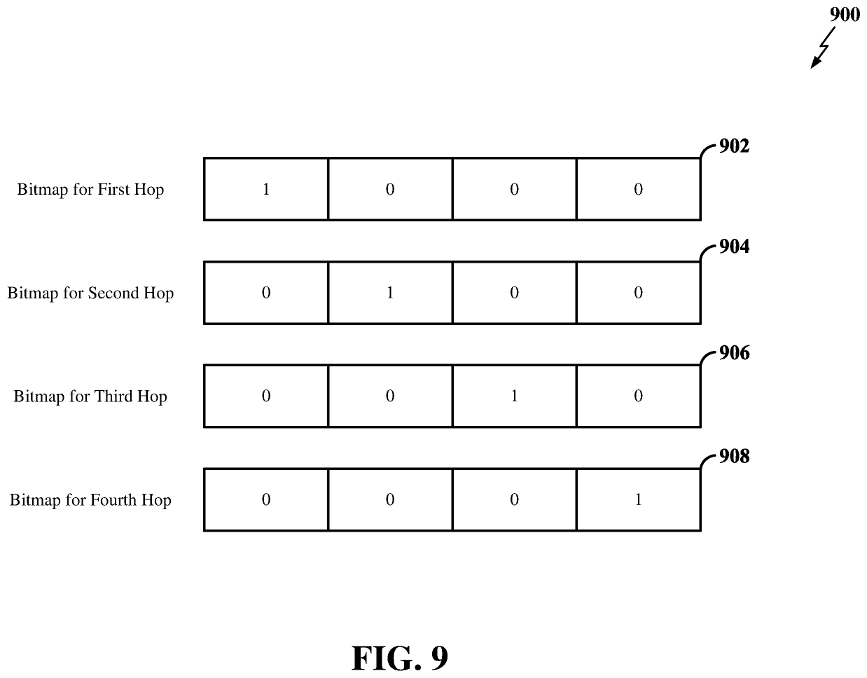

FIG. 9 is a diagram illustrating an example of bit maps for indicating a subset of available SRS resources according to some aspects. Here, a first bit map 902 is provided for a first hop, a second bit map 904 is provided for a second hop, a third bit map 906 is provided for a third hop, and a fourth bit map 908 is provided for a fourth hop. Given the value [1000] for the first bit map 902, for the first hop, the UE will transmit the SRS on the first RB (RB0). Given the value [0100] for the second bit map 904, for the second hop, the UE will transmit the SRS on the second RB (RB1), and so on.

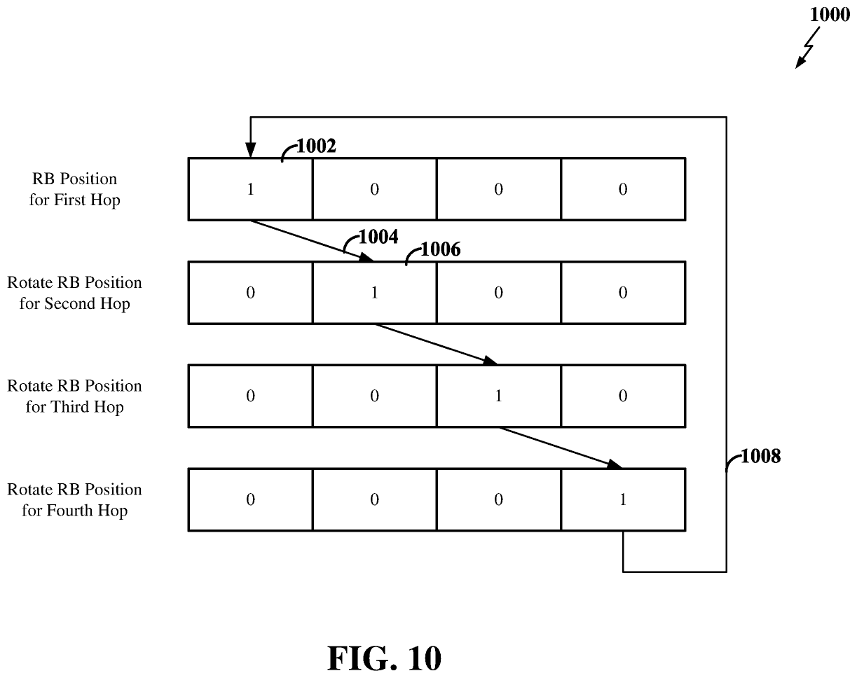

FIG. 10 is a diagram illustrating an example of using cycling for indicating a subset of available SRS resources according to some aspects. Here, the RB position 1002 used for the first hop for its SRS transmission is rotated (shifted) as indicated by the arrow 1004, so that the second hop uses the RB position 1006 for its SRS transmission. Here, for the first hop, the UE will transmit the SRS on the first RB (RB0), for the second hop, the UE will transmit the SRS on the second RB (RB1), and so on. FIG. 10 also illustrates that the cycling pattern may repeat as indicated by the arrow 1008. For example, for the fifth hop, the UE will transmit the SRS on the first RB (RB0), for the sixth hop, the UE will transmit the SRS on the second RB (RB1), and so on.

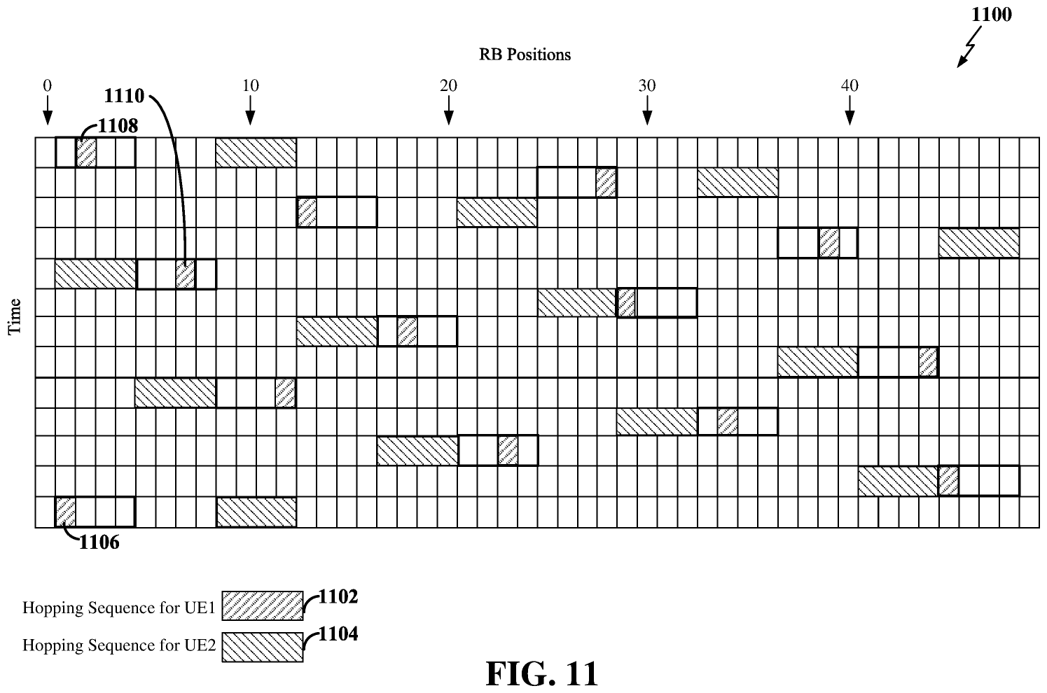

FIG. 11 is a diagram illustrating another example of SRS frequency hopping using a subset of available SRS resources specified by cycling according to some aspects. Here, a frequency hopping pattern 1100 includes a first hopping sequence 1102 for a first UE (UE1) and a second hopping sequence 1104 for a second UE (UE2). As indicated for example by sub-hops 1106, 1108, and 1110, the sub-hop (RB) used for transmitting the SRS is shifted from hop to hop. Here, for the sub-hop 1106, the UE will transmit the SRS on the first RB (RB0), for the sub-hop 1108, the UE will transmit the SRS on the second RB (RB1), and so on.

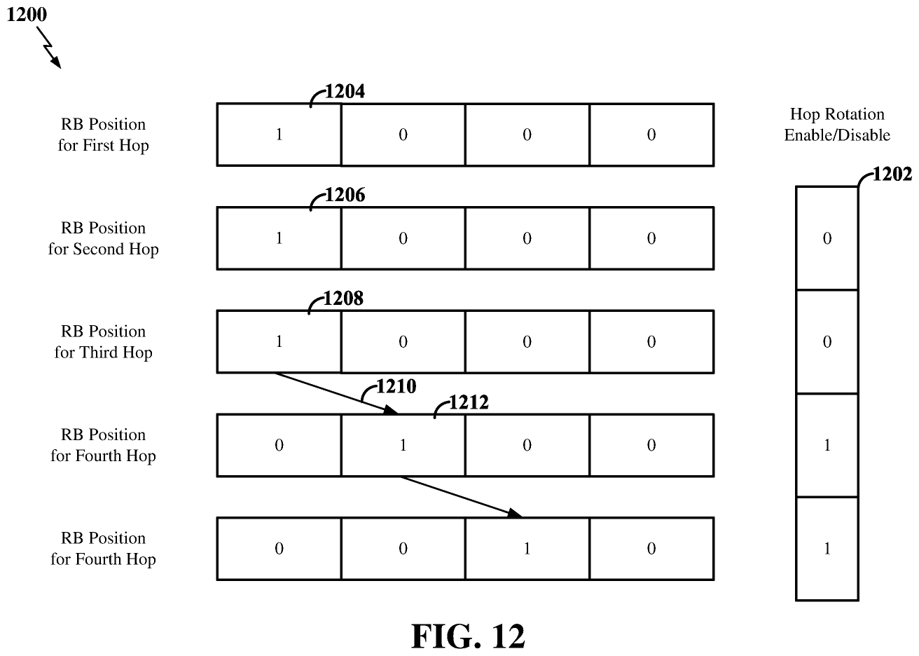

FIG. 12 is a diagram illustrating an example of using selective cycling at different hops for indicating a subset of available SRS resources according to some aspects. Here, a hop rotation enable/disable sequence (e.g., bit map) 1202 is used to indicate whether sub-hop rotation is applied for a given hop. In this example, as indicated by sub-hops (RBs) 1204, 1206, and 1208, sub-hop rotation is not applied for hops two and three since the bits for hops two and three in the enable/disable sequence 1202 are set to 0. In contrast, since the bits for hops four and five in the enable/disable sequence 1202 are set to 1, sub-hop rotation is applied for hops four and five (e.g., as indicated by the arrow 1210 and sub-hop (RB) 1212.

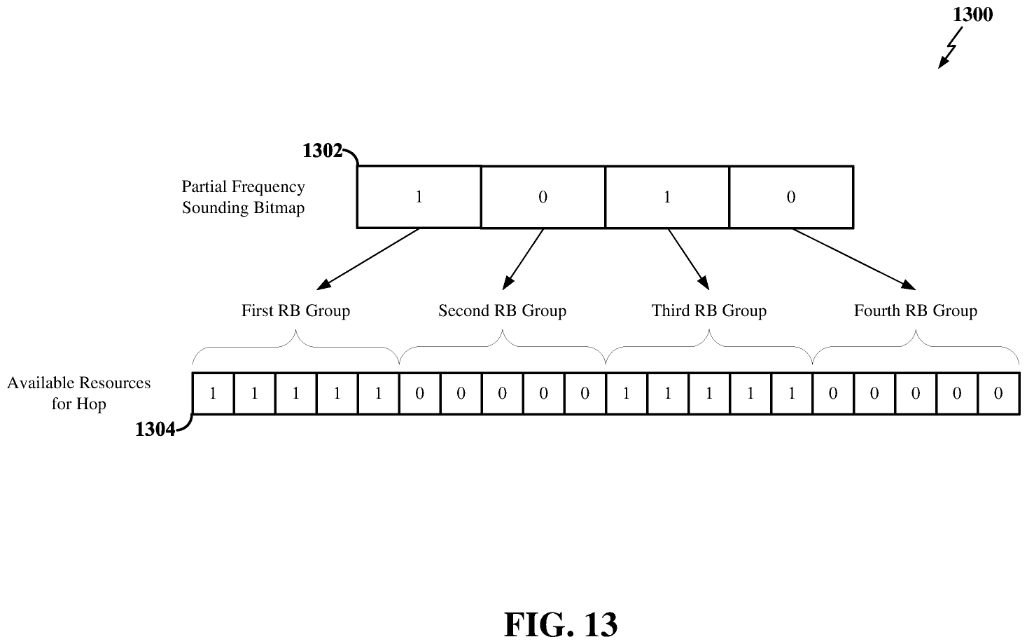

FIG. 13 is a diagram illustrating an example bit map for indicating groups of resource blocks according to some aspects. Here, a first bit of the bit map 1302 maps to a first RB group of the set of available RBs 1304 for a hop, a second bit of the bit map 1302 maps to a second RB group of the set of available RBs 1304 for the hop, and so on.

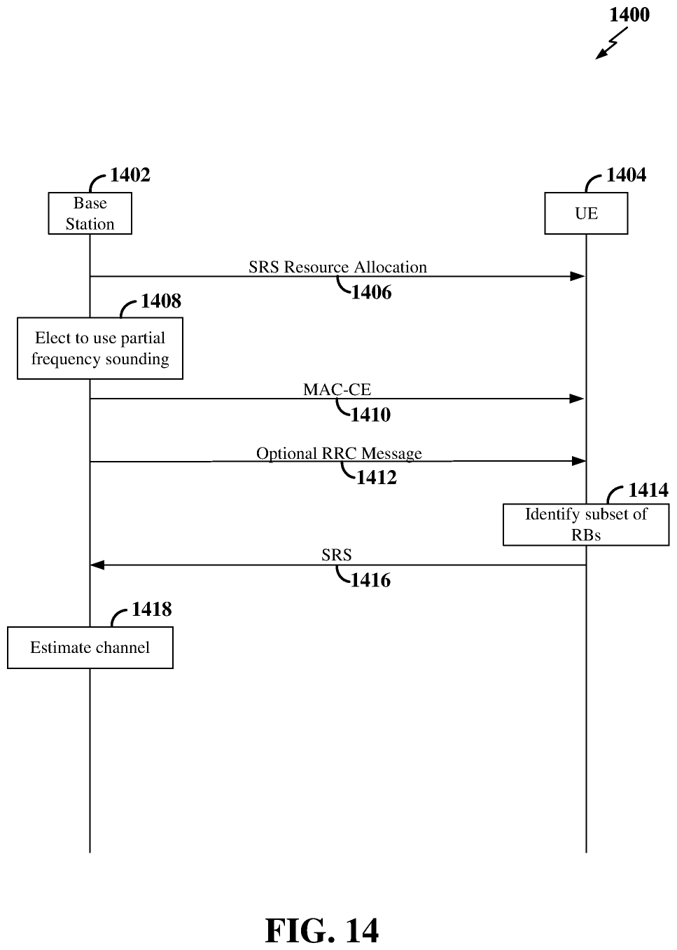

FIG. 14 is a signaling diagram 1400 illustrating an example of SRS-related signaling in a wireless communication system including a base station (BS) 1402 and a UE 1404. In some examples, the BS 1402 may correspond to any of the base stations or scheduling entities shown in any of FIGS. 1, 2, 15, 16, and 20. In some examples, the UE 1404 may correspond to any of the UEs or scheduled entities shown in any of FIGS. 1, 2, 15, 16, and 17.

At step 1406 of FIG. 14, the BS 1402 may send SRS resource allocation information to the UE 1404. For example, the BS 1402 may identify at least one resource set the UE is to use for SRS transmissions, a bandwidth configuration (e.g., hopping parameters) for the SRS transmissions, and/or other SRS configuration information. In some examples, the BS 1402 may transmit a first configuration to the UE 1404 specifying an SRS bandwidth. In some examples, the BS 1402 may transmit a second configuration to the UE 1404 specifying an SRS hopping bandwidth. The BS 1402 may send the SRS resource allocation information to the UE 1404 via RRC signaling, a DCI, a MAC-CE, or some other type of signaling.

At step 1408, the BS 1402 elects to use partial frequency sounding. For example, the BS 1402 may determine that a higher SRS capacity is needed to adequately serve the UEs under the BS 1402. In some examples, this determination may also take into account whether the channel to the UE 1404 is sufficiently constant (e.g., the channel has low selectivity) so that SRS information for RBs that the UE 1404 does not use to transmit SRS (due to the partial frequency sounding) may be interpolated from the SRS information received from the UE in other RBs (e.g., RBs that are adjacent to the RBs that the UE does not use to transmit SRS due to partial frequency sounding).

At step 1410, the BS 1402 transmits a MAC-CE to the UE 1404, where the MAC-CE explicitly or implicitly indicates partial frequency sounding. For example, the MAC-CE may include a bit map that identifies the subset RBs to be used for each hop. Also as mentioned above, the MAC-CE may include a bitmask that indicates which SRS resource sets are to use partial frequency sounding.

At optional step 1412, the BS 1402 may transmit an RRC configuration that identifies the subset of RBs to be used by the UE 1404 for each hop.

At step 1414, the UE 1404 identifies the subset RBs to use for each hop based on a MAC-CE transmitted at step 1410, an RRC configuration transmitted at step 1412 and/or SRS configuration information maintained at the UE 1404. In some examples, the SRS configuration information may indicate one or more of: how cycling is to be done, how a bit map maps to blocks of RBs, other partial frequency sounding information, or a combination thereof.

In some examples, the UE 1404 may determine the SRS bandwidth to use from a first configuration received from the base station 1402 (e.g., the SRS resource allocation discussed above). In some examples, the UE 1404 may determine the SRS hopping bandwidth to use from a second configuration received from the base station 1402 (e.g., the SRS resource allocation or the RRC message discussed above). In some examples, the UE 1404 may determine the RBs to use at each hop from a third configuration received from the base station 1402 (e.g., the MAC-CE discussed above).

At step 1416, the UE 1404 transmits an SRS at each hop using the subset of RBs identified at step 1414. For example, the UE 1404 may generate an SRS for the specified number of RBs (e.g., one RB, two RBs, etc.) for a hop. The UE 1404 may then transmit an SRS on a first RB for a first hop, transmit an SRS on a first RB or a second RB for a second hop, and so on.

At step 1418, the BS 1402 may estimate the uplink channel from the UE 1404 to the BS 1402 based on the SRS received from the UE 1404. The BS 1402 may then use this channel estimate for subsequent scheduling of the UE 1404.

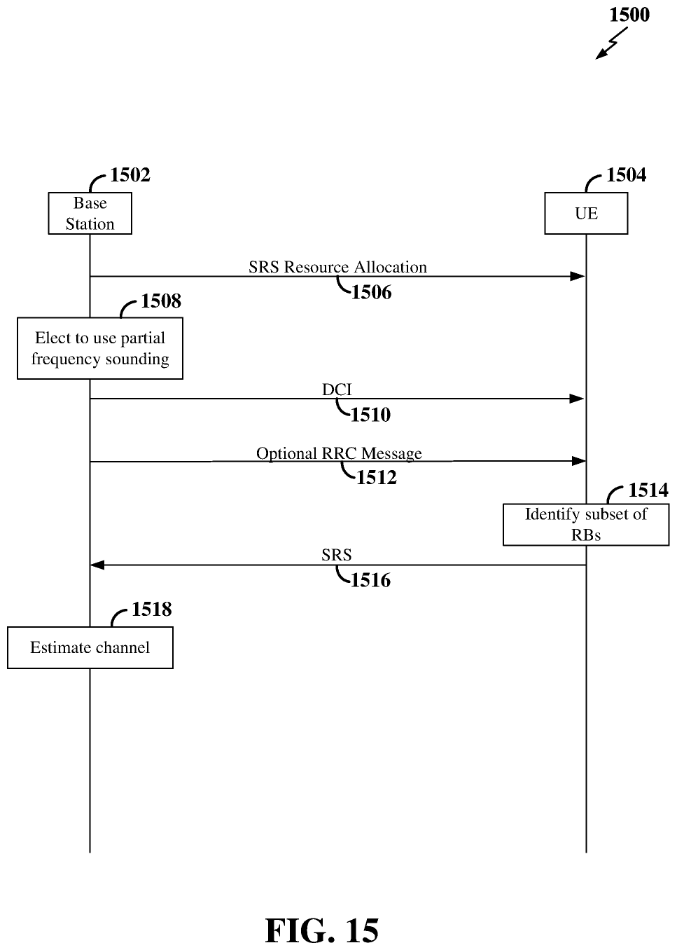

FIG. 15 is a signaling diagram 1500 illustrating another example of SRS-related signaling in a wireless communication system including a base station (BS) 1502 and a UE 1504. In some examples, the BS 1502 may correspond to any of the base stations or scheduling entities shown in any of FIGS. 1, 2, 14, 16, and 20. In some examples, the UE 1504 may correspond to any of the UEs or scheduled entities shown in any of FIGS. 1, 2, 14, 16, and 17.

At step 1506 of FIG. 15, the BS 1502 may send SRS resource allocation information to the UE 1504. In some examples, the BS 1502 may send SRS-related information to the UE 1504 in a similar manner as discussed above at step 1406 of FIG. 14.

At step 1506, the BS 1502 elects to use partial frequency sounding. For example, the BS 1502 may perform operations similar to those discussed above at step 1408 of FIG. 14.

At step 1510, the BS 1502 transmits a DCI to the UE 1504, where the DCI explicitly or implicitly indicates partial frequency sounding. For example, the DCI may include a bit map that identifies the subset RBs to be used for each hop. As another example, partial frequency sounding may be indicated based on SRS request field carried by the DCI and an associated TriggerList as discussed above. Also as mentioned above, the DCI may include a bitmask that indicates which SRS resource sets are to use partial frequency sounding. In addition, in some examples, some of the bits of the DCI (e.g., FDRA bits when the DCI is not scheduling a data transmission) may be repurposed to carry partial frequency sounding information (e.g., a bit map).

At optional step 1512, the BS 1502 may transmit an RRC configuration that identifies the subset of RBs to be used by the UE 1504 for each hop.

At step 1514, the UE 1504 identifies the subset RBs to use for each hop based on a DCI transmitted at step 1510, an RRC configuration transmitted at step 1512 and/or SRS configuration information maintained at the UE 1504. In some examples, the SRS configuration information may indicate one or more of: how cycling is to be done, TriggerList associations for partial frequency sounding, how a bit map maps to blocks of RBs, other partial frequency sounding information, or a combination thereof.

In some examples, the UE 1504 may determine the SRS bandwidth to use from a first configuration received from the base station 1502 (e.g., the SRS resource allocation discussed above). In some examples, the UE 1504 may determine the SRS hopping bandwidth to use from a second configuration received from the base station 1502 (e.g., the SRS resource allocation or the RRC message discussed above). In some examples, the UE 1504 may determine the RBs to use at each hop from a third configuration received from the base station 1502 (e.g., the MAC-CE discussed above).

At step 1516, the UE 1504 transmits an SRS at each hop using the subset of RBs identified at step 1514. For example, the UE 1504 may generate an SRS for the specified number of RBs (e.g., one RB, two RBs, etc.) for a hop. The UE 1504 may then transmit an SRS on a first RB for a first hop, transmit an SRS on a first RB or a second RB for a second hop, and so on.

At step 1518, the BS 1502 may estimate the uplink channel from the UE 1504 to the BS 1502 based on the SRS received from the UE 1504. The BS 1502 may then use this channel estimate for subsequent scheduling of the UE 1504.

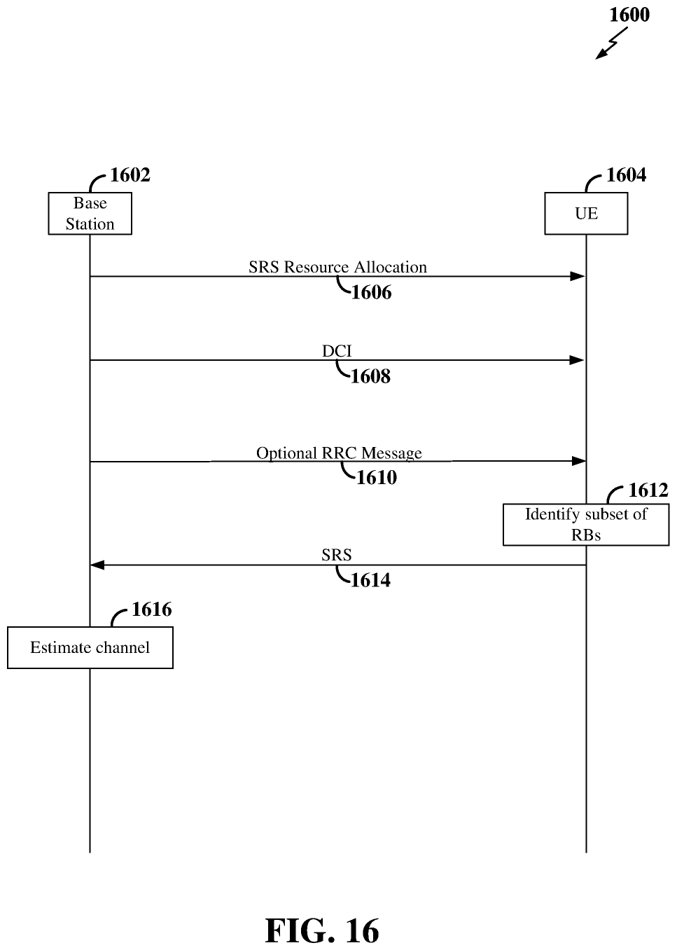

FIG. 16 is a signaling diagram 1600 illustrating another example of SRS-related signaling in a wireless communication system including a base station (BS) 1602 and a UE 1604. In some examples, the BS 1602 may correspond to any of the base stations or scheduling entities shown in any of FIGS. 1, 2, 14, 15, and 20. In some examples, the UE 1604 may correspond to any of the UEs or scheduled entities shown in any of FIGS. 1, 2, 14, 15, and 17.

At step 1606 of FIG. 16, the BS 1602 may send SRS resource allocation information to the UE 1604. In some examples, the BS 1602 may send SRS-related information to the UE 1604 in a similar manner as discussed above at step 1406 of FIG. 14.

At step 1606, the BS 1602 elects to use partial frequency sounding. In some examples, the BS 1602 may perform operations similar to those discussed above at step 1408 of FIG. 14.

At step 1608, the BS 1602 transmits a DCI to the UE 1604, where the DCI indicates that the UE 1604 is to use partial frequency sounding. For example, the DCI may include a bit where a value of “1” indicates that partial frequency sounding is enabled for the UE 1604.

At optional step 1610, the BS 1602 may transmit an RRC configuration that identifies the subset of RBs to be used by the UE 1604 for each hop.

At step 1612, the UE 1604 identifies the specific subset of RBs to be used at each hop. In some examples, the identification of the subset of RBs is based on an autonomous selection by the UE 1604, an RRC configuration transmitted at step 1612 and/or SRS configuration information maintained at the UE 1604. As discussed above, in some examples, autonomous selection by the UE 1604 may involve using a random selection process (e.g., based on a scrambling ID or some other known seed) to identify the subset of RBs. Also as discussed above, in some examples, autonomous selection by the UE 1604 may involve a round robin selection process to identify the subset of RBs.

In some examples, the UE 1604 may determine the SRS bandwidth to use from a first configuration received from the base station 1602 (e.g., the SRS resource allocation discussed above). In some examples, the UE 1604 may determine the SRS hopping bandwidth to use from a second configuration received from the base station 1602 (e.g., the SRS resource allocation or the RRC message discussed above). In some examples, the UE 1604 may determine the RBs to use at each hop from a third configuration received from the base station 1602 (e.g., the MAC-CE discussed above).

At step 1614, the UE 1604 transmits an SRS at each hop using the subset of RBs identified at step 1614. For example, the UE 1604 may generate an SRS for the specified number of RBs (e.g., one RB, two RBs, etc.) for a hop. The UE 1604 may then transmit an SRS on a first RB for a first hop, transmit an SRS on a first RB or a second RB for a second hop, and so on.

In scenarios where the UE 1604 uses an autonomous selection process (e.g., algorithm) to identify the specific subset of RBs to be used at each hop, the BS 1602 may perform a similar process to identify the specific subset of RBs that the UE 1604 will use at each hop. For example, the BS 1602 may use the same random selection process (e.g., based on a scrambling ID or some other known seed) to identify the subset of RBs, the same round robin selection process, and so on.

At step 1616, the BS 1602 may estimate the uplink channel from the UE 1604 to the BS 1602 based on the SRS received from the UE 1604. The BS 1602 may then use this channel estimate for subsequent scheduling of the UE 1604.

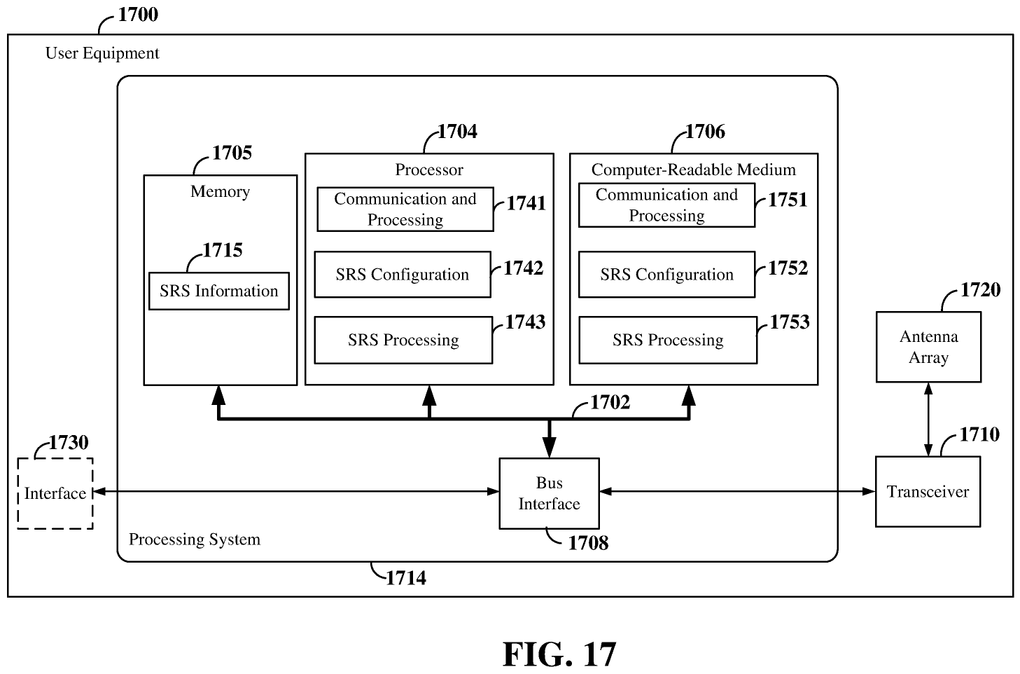

FIG. 17 is a block diagram illustrating an example of a hardware implementation for a UE 1700 employing a processing system 1714. For example, the UE 1700 may be a device configured to wirelessly communicate with a base station, as discussed in any one or more of FIGS. 1-16. In some implementations, the UE 1700 may correspond to any of the UEs or scheduled entities shown in any of FIGS. 1, 2, 5-9, 12-15, and 16.

In accordance with various aspects of the disclosure, an element, or any portion of an element, or any combination of elements may be implemented with the processing system 1714. The processing system 1714 may include one or more processors 1704. Examples of processors 1704 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1700 may be configured to perform any one or more of the functions described herein. That is, the processor 1704, as utilized in a UE 1700, may be used to implement any one or more of the processes and procedures described herein.

The processor 1704 may in some instances be implemented via a baseband or modem chip and in other implementations, the processor 1704 may itself comprise a number of devices distinct and different from a baseband or modem chip (e.g., in such scenarios as may work in concert to achieve embodiments discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1714 may be implemented with a bus architecture, represented generally by the bus 1702. The bus 1702 may include any number of interconnecting buses and bridges depending on the specific application of the processing system 1714 and the overall design constraints. The bus 1702 communicatively couples together various circuits including one or more processors (represented generally by the processor 1704), a memory 1705, and computer-readable media (represented generally by the computer-readable medium 1706). The bus 1702 may also link various other circuits such as timing sources, peripherals, voltage regulators, and power management circuits, which are well known in the art, and therefore, will not be described any further. A bus interface 1708 provides an interface between the bus 1702 and a transceiver 1710 and between the bus 1702 and an interface 1730. The transceiver 1710 provides a communication interface or means for communicating with various other apparatus over a wireless transmission medium. In some examples, the UE may include two or more transceivers 1710, each configured to communicate with a respective network type (e.g., terrestrial or non-terrestrial). The interface 1730 provides a communication interface or means of communicating with various other apparatuses and devices (e.g., other devices housed within the same apparatus as the UE or other external apparatuses) over an internal bus or external transmission medium, such as an Ethernet cable. Depending upon the nature of the apparatus, the interface 1730 may include a user interface (e.g., keypad, display, speaker, microphone, joystick). Of course, such a user interface is optional, and may be omitted in some examples, such as an IoT device.

The processor 1704 is responsible for managing the bus 1702 and general processing, including the execution of software stored on the computer-readable medium 1706. The software, when executed by the processor 1704, causes the processing system 1714 to perform the various functions described below for any particular apparatus. The computer-readable medium 1706 and the memory 1705 may also be used for storing data that is manipulated by the processor 1704 when executing software.

One or more processors 1704 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1706.

The computer-readable medium 1706 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1706 may reside in the processing system 1714, external to the processing system 1714, or distributed across multiple entities including the processing system 1714. The computer-readable medium 1706 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

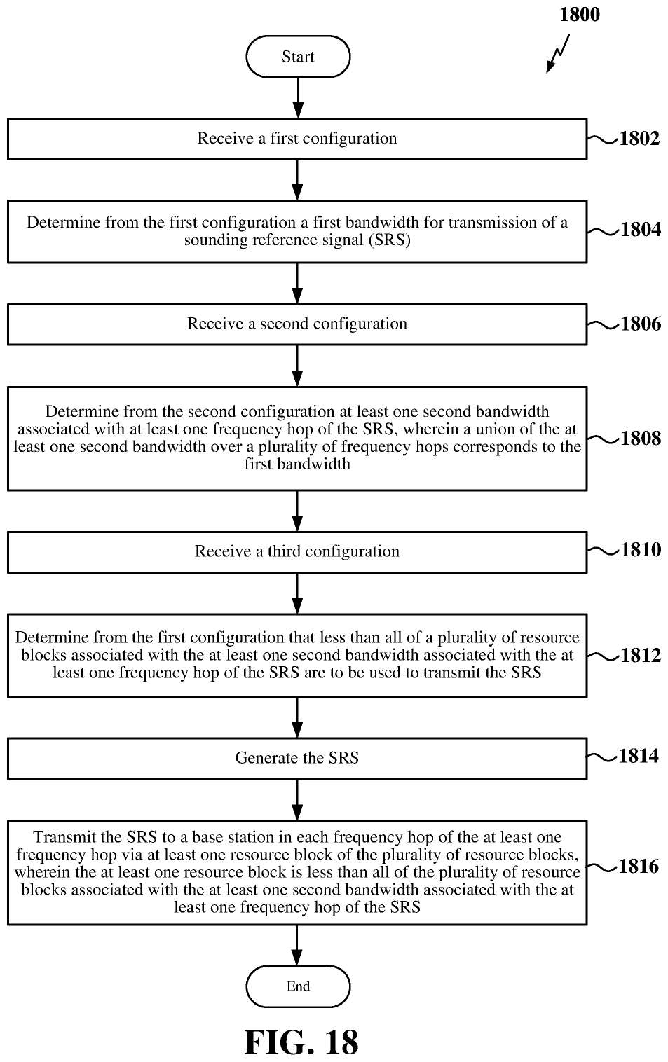

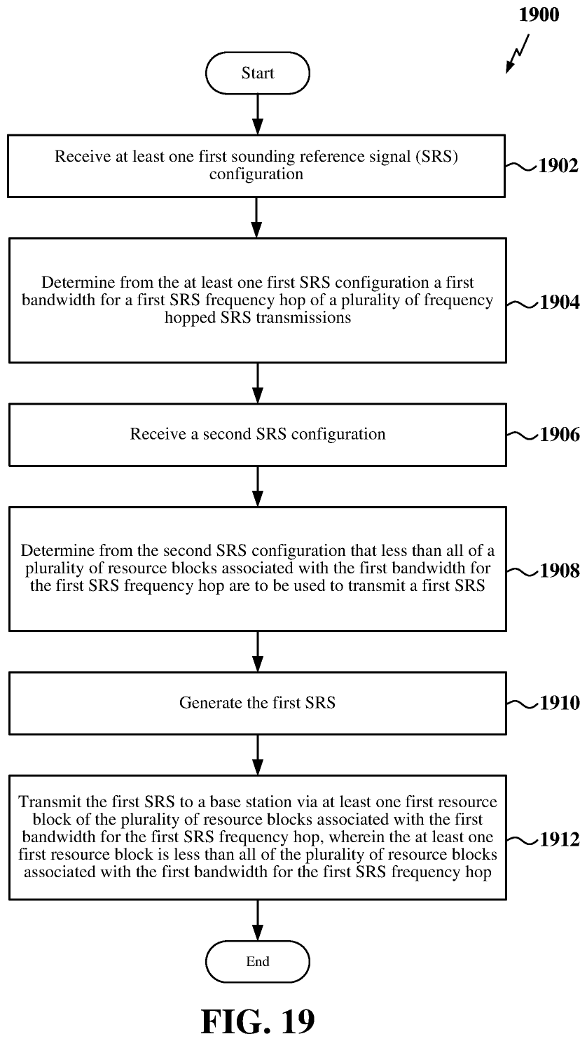

The UE 1700 may be configured to perform any one or more of the operations described herein (e.g., as described above in conjunction with FIGS. 1-16 and as described below in conjunction with FIGS. 18 and 19). In some aspects of the disclosure, the processor 1704, as utilized in the UE 1700, may include circuitry configured for various functions.

The processor 1704 may include communication and processing circuitry 1741. The communication and processing circuitry 1741 may be configured to communicate with a base station, such as a gNB. The communication and processing circuitry 1741 may include one or more hardware components that provide the physical structure that performs various processes related to wireless communication (e.g., signal reception and/or signal transmission) as described herein. The communication and processing circuitry 1741 may further include one or more hardware components that provide the physical structure that performs various processes related to signal processing (e.g., processing a received signal and/or processing a signal for transmission) as described herein. In some examples, the communication and processing circuitry 1741 may include two or more transmit/receive chains, each configured to process signals in a different RAT (or RAN) type. The communication and processing circuitry 1741 may further be configured to execute communication and processing software 1751 included on the computer-readable medium 1706 to implement one or more functions described herein.

In some examples, the communication and processing circuitry 1741 may be configured to receive and process downlink beamformed signals at a mmWave frequency or a sub-6 GHz frequency via the transceiver 1710 and an antenna array 1720. For example, the communication and processing circuitry 1741 may be configured to receive a respective reference signal (e.g., SSB or CSI-RS) on each of a plurality of downlink beams from the base station during a downlink beam sweep via at least one first antenna panel of the antenna array 1720. The communication and processing circuitry 1741 may further be configured to transmit a beam measurement report to the base station.

In some examples, the communication and processing circuitry 1741 may further be configured to generate and transmit uplink beamformed signals at a mmWave frequency or a sub-6 GHz frequency via the transceiver 1710 and the antenna array 1720. For example, the communication and processing circuitry 1741 may be configured to transmit a respective reference signal (e.g., SRS or DMRS) on each of a plurality of uplink beams to the base station during an uplink beam sweep via at least one second antenna panel of the antenna array 1720.

The communication and processing circuitry 1741 may further be configured to generate and transmit a request to the base station. For example, the request may be included in a MAC-CE carried in a PUSCH, UCI in a PUCCH or PUSCH, a random access message, or an RRC message. The communication and processing circuitry 1741 may further be configured to generate and transmit a scheduling request (e.g., via UCI in a PUCCH) to the base station to receive an uplink grant for the PUSCH carrying the MAC-CE including the request for uplink beam refinement.

The communication and processing circuitry 1741 may further be configured to generate and transmit an uplink signal on one or more uplink transmit beams applied to the uplink signal. The uplink signal may include, for example, a PUCCH, PUSCH, SRS, DMRS, or PRACH.

The communication and processing circuitry 1741 may further be configured to control the antenna array 1720 and the transceiver 1710 to search for and identify a plurality of downlink transmit beams during a downlink beam sweep. The communication and processing circuitry 1741 may further be configured to obtain a plurality of beam measurements on each of a plurality of downlink receive beams via the antenna array 1720 for each of the identified downlink transmit beams. The communication and processing circuitry 1741 may further be configured to generate a beam measurement report for transmission to the base station using the communication and processing circuitry 1741.

The communication and processing circuitry 1741 may further be configured to identify one or more selected uplink beam(s) based on the beam measurements obtained from the downlink beam reference signals. In some examples, the communication and processing circuitry 1741 may be configured to compare the respective RSRP (or other beam measurement) measured on each of the downlink receive beams for each of the serving downlink transmit beams to identify the serving downlink receive beams and to further utilize the serving downlink receive beams as the selected uplink transmit beams. Each serving downlink receive beam may have the highest measured RSRP (or other beam measurement) for one of the downlink transmit beams.

The communication and processing circuitry 1741 may be configured to generate one or more uplink transmit beams for transmission in an uplink beam sweep. Each uplink transmit beam may carry an uplink reference signal (e.g., an SRS) for measurement by the base station. The communication and processing circuitry 1741 may further be configured to identify the selected uplink transmit beam(s) selected by the base station based on the uplink beam measurements. For example, the communication and processing circuitry 1741 may be configured to receive an indication of the selected uplink transmit beam(s) from the base station.

In some implementations where the communication involves receiving information, the communication and processing circuitry 1741 may obtain information from a component of the UE 1700 (e.g., from the transceiver 1710 that receives the information via radio frequency signaling or some other type of signaling suitable for the applicable communication medium), process (e.g., decode) the information, and output the processed information. For example, the communication and processing circuitry 1741 may output the information to another component of the processor 1704, to the memory 1705, or to the bus interface 1708. In some examples, the communication and processing circuitry 1741 may receive one or more of signals, messages, other information, or any combination thereof. In some examples, the communication and processing circuitry 1741 may receive information via one or more channels. In some examples, the communication and processing circuitry 1741 may include functionality for a means for receiving. In some examples, the communication and processing circuitry 1741 may include functionality for a means for decoding.

In some implementations where the communication involves sending (e.g., transmitting) information, the communication and processing circuitry 1741 may obtain information (e.g., from another component of the processor 1704, the memory 1705, or the bus interface 1708), process (e.g., encode) the information, and output the processed information. For example, the communication and processing circuitry 1741 may output the information to the transceiver 1710 (e.g., that transmits the information via radio frequency signaling or some other type of signaling suitable for the applicable communication medium). In some examples, the communication and processing circuitry 1741 may send one or more of signals, messages, other information, or any combination thereof. In some examples, the communication and processing circuitry 1741 may send information via one or more channels. In some examples, the communication and processing circuitry 1741 may include functionality for a means for sending (e.g., a means for transmitting). In some examples, the communication and processing circuitry 1741 may include functionality for a means for encoding.

The processor 1704 may include SRS configuration circuitry 1742 configured to perform SRS configuration-related operations as discussed herein (e.g., one or more of the operations described in conjunction with FIGS. 7-16). The SRS configuration circuitry 1742 may include functionality for a means for receiving (e.g., as described at step 1406, 1410 and/or step 1412 of FIG. 14, step 1510 and/or step 1506, 1510, and/or 1512 of FIG. 15, step 1606, 1608, and/or step 1610 of FIG. 16, at block 1802, 1806, and/or 1810 of FIG. 18, and/or at block 1902 and/or 1906 of FIG. 19). The SRS configuration circuitry 1742 may include functionality for a means for determining a bandwidth (e.g., as described at step 1414 of FIG. 14, step 1514 of FIG. 15, step 1612 of FIG. 16, at block 1804 and/or 1808 of FIG. 18 and/or at block 1904 of FIG. 19). The SRS configuration circuitry 1742 may include functionality for a means for determining that less than all RBs are to be used to transmit an SRS (e.g., as described at step 1414 of FIG. 14, step 1514 of FIG. 15, step 1612 of FIG. 16, at block 1812 of FIG. 18 and/or at block 1908 of FIG. 19). The SRS configuration circuitry 1742 may further be configured to execute SRS configuration software 1752 included on the computer-readable medium 1706 to implement one or more functions described herein.

The processor 1704 may include SRS processing circuitry 1743 configured to perform SRS processing-related operations as discussed herein (e.g., one or more of the operations described in conjunction with FIGS. 7-16). The SRS processing circuitry 1743 may include functionality for a means for generating SRS (e.g., as described at step 1414 of FIG. 14, step 1514 of FIG. 15, step 1612 of FIG. 16, at block 1814 of FIG. 18, and/or at block 1910 of FIG. 19). The SRS processing circuitry 1743 may include functionality for a means for transmitting SRS (e.g., as described at step 1416 of FIG. 14, step 1516 of FIG. 15, step 1614 of FIG. 16, at block 1816 of FIG. 18, and/or at block 1912 of FIG. 19). The SRS processing circuitry 1743 may further be configured to execute SRS processing software 1753 included on the computer-readable medium 1706 to implement one or more functions described herein.

FIG. 18 is a flow chart illustrating an example process 1800 for a wireless communication system in accordance with some aspects of the present disclosure. As described below, some or all illustrated features may be omitted in a particular implementation within the scope of the present disclosure, and some illustrated features may not be required for implementation of all embodiments. In some examples, the process 1800 may be carried out by the UE 1700 illustrated in FIG. 17. In some examples, the process 1800 may be carried out by any suitable apparatus or means for carrying out the functions or algorithm described below.

At block 1802, a UE may receive a first configuration. For example, the SRS configuration circuitry 1742 together with the communication and processing circuitry 1741 and the transceiver 1710, shown and described above in connection with FIG. 17, may monitor a designated downlink channel (e.g., a PDCCH or a PDSCH) from a gNB and decode signals received on the channel to identify information (e.g., a DCI, a MAC-CE, or an RRC configuration) directed to the UE.

At block 1804, the UE may determine from the first configuration a first bandwidth for transmission of a sounding reference signal (SRS). For example, the SRS configuration circuitry 1742 may process the configuration received at block 1802 to determine an SRS bandwidth indicated by an SRS configuration.

At block 1806, the UE may receive a second configuration. For example, the SRS configuration circuitry 1742 together with the communication and processing circuitry 1741 and the transceiver 1710, shown and described above in connection with FIG. 17, may monitor a designated downlink channel (e.g., a PDCCH or a PDSCH) from a gNB and decode signals received on the channel to identify information (e.g., a DCI, a MAC-CE, or an RRC configuration) directed to the UE. In some examples, the first configuration and the second configuration may be received in the same message. In some examples, the first configuration and the second configuration may be received in a common configuration.

At block 1808, the UE may determine from the second configuration at least one second bandwidth associated with at least one frequency hop of the SRS, wherein a union of the at least one second bandwidth over a plurality of frequency hops corresponds to the first bandwidth. For example, the SRS configuration circuitry 1742 may process the configuration received at block 1806 to determine an SRS hopping bandwidth indicated by an SRS configuration.

At block 1810, the UE may receive a third configuration. For example, the SRS configuration circuitry 1742 together with the communication and processing circuitry 1741 and the transceiver 1710, shown and described above in connection with FIG. 17, may monitor a designated downlink channel (e.g., a PDCCH or a PDSCH) from a gNB and decode signals received on the channel to identify information (e.g., a DCI, a MAC-CE, or an RRC configuration) directed to the UE.

In some examples, receiving the third configuration may include receiving a medium access control-control element (MAC-CE) that includes the third configuration, receiving a downlink control information (DCI) that includes the third configuration, or receiving a radio resource control (RRC) message that includes the third configuration.

At block 1812, the UE may determine from the third configuration that less than all of a plurality of resource blocks associated with the at least one second bandwidth associated with the at least one frequency hop of the SRS are to be used to transmit the SRS. For example, the SRS configuration circuitry 1742 may process (e.g. parse) a message received at block 1810 to determine whether the message implicitly or explicitly indicates that the UE is to use partial frequency sounding.

At block 1814, the UE may generate the SRS. For example, the SRS processing circuitry 1743, shown and described above in connection with FIG. 17, may generate an SRS sequence for each hop by cyclic shifting a base sequence (e.g., a Zadoff-Chu sequence). In some examples, the generation of the SRS may depend on the number of RBs in which the SRS will be transmitted.

At block 1816, the UE may transmit the SRS to a base station in each frequency hop of the at least one frequency hop via at least one resource block of the plurality of resource blocks, wherein the at least one resource block is less than all of the plurality of resource blocks associated with the at least one second bandwidth associated with the at least one frequency hop of the SRS. For example, the SRS processing circuitry 1743 together with the communication and processing circuitry 1741 and the transceiver 1710 may identify, for each hop with an SRS bandwidth, the specific RB(s) to be used for an SRS transmission. In some examples, the same RB(s) will be used for each hop. In some examples (e.g., where cycling is employed), different RBs will be used for different hops. Then, for each hop, the SRS processing circuitry 1743 together with the communication and processing circuitry 1741 and the transceiver 1710 may transmit on the appropriate RB(s) the SRS generated at block 1804 for that hop.

In some examples, the third configuration further specifies a location of the at least one resource block within the plurality of resource blocks associated with the at least one second bandwidth associated with the at least one frequency hop of the SRS. In some examples, the at least one resource block may include at least two resource blocks, and the third configuration further specifies locations of the at least two resource blocks within the plurality of resource blocks.

In some examples, the third configuration may include a bit map wherein a first bit of the bit map is mapped to a first subset of the plurality of resource blocks, and a second bit of the bit map is mapped to a second subset of the plurality of resource blocks. In some examples, the method may further include determining that the first bit is set, and transmitting the SRS on the first subset of the plurality of resource blocks after determining that the first bit is set.

In some examples, the at least one frequency hop may include a plurality of frequency hopped SRS transmissions. In some examples, the plurality of resource blocks may include a first set of resource blocks of a plurality of sets of resource blocks designated for the plurality of frequency hopped SRS transmissions. In some examples, the third configuration may include an index indicating at least one resource block location for each set of the plurality of sets of resource blocks, and the method further may include transmitting the plurality of frequency hopped SRS transmissions at the at least one resource block location for each set of the plurality of sets of resource blocks.

In some examples, the third configuration further specifies a cycling of resource blocks to be used for different hops of the plurality of frequency hopped SRS transmissions. In some examples, the cycling may be indicated by a first bit map for a first hop of the plurality of frequency hopped SRS transmissions, and a second bit map for a second hop of the plurality of frequency hopped SRS transmissions. In some examples, the cycling may include a shift of a resource block location. In some examples, each set of the plurality of sets of resource blocks may include a first resource block position and a second resource block position, and the cycling of resource blocks indicates that a first SRS transmission for a first hop occurs at the first resource block position and a second SRS transmission for a second hop occurs at the second resource block position. In some examples, the third configuration further specifies whether the cycling is to be applied to a particular hop of the plurality of frequency hopped SRS transmissions. In some examples, the third configuration may include a bit map that specifies whether the cycling is to be applied to a plurality of resource block positions.

In some examples, the third configuration further specifies whether SRS transmission is activated or deactivated for a hop of the plurality of frequency hopped SRS transmissions. In some examples, the third configuration may further include a bit map comprising: a first bit that specifies whether SRS transmission is activated or deactivated for a first hop of the plurality of frequency hopped SRS transmissions, and a second bit that specifies whether SRS transmission is activated or deactivated for a second hop of the plurality of frequency hopped SRS transmissions.

In some examples, the third configuration further specifies a range of resource blocks for the at least one resource block. In some examples, the third configuration further specifies a starting resource block and a quantity of resource blocks for the at least one resource block.

In some examples, receiving the third configuration may include receiving a downlink control information (DCI) format 0_1 that includes the third configuration. In some examples, the receiving the third configuration may include receiving a downlink control information (DCI) that does not schedule a data transmission and includes repurposed bits that carry the third configuration.

In some examples, receiving the third configuration may include receiving a downlink control information (DCI), the DCI specifies a first SRS resource set and a second SRS resource set, the first SRS resource set is associated with a first trigger list, the second SRS resource set is associated with a second trigger list, the first trigger list indicates whether a first SRS is transmitted on less than all of a plurality of resource blocks of the first SRS resource set, and the second trigger list indicates whether a second SRS is transmitted on less than all of a plurality of resource blocks of the second SRS resource set. In some examples, the method may further include receiving a radio resource control (RRC) message that identifies at least one resource of the first SRS resource set that is designated for transmission of the first SRS. In some examples, the third configuration may include a bit map that identifies at least one resource of the first SRS resource set that is designated for transmission of the first SRS. In some examples, the third configuration further may include a first bit map that identifies at least one resource of the first SRS resource set that is designated for transmission of the first SRS, and a second bit map that identifies at least one resource of the second SRS resource set that is designated for transmission of the second SRS.

In some examples, receiving the third configuration may include receiving a downlink control information (DCI) or a radio resource control (RRC) configuration, and the DCI or the RRC configuration may include a bit that indicates that less than all of the plurality of resource blocks designated for the transmission of the SRS are to be used to transmit the SRS. In some examples, the method may further include randomly selecting the at least one resource block (for the transmission of the SRS). In some examples, randomly selecting the at least one resource block is based on a scrambling identifier for the user equipment. In some examples, the method may further include selecting the at least one resource block (for the transmission of the SRS) according to a defined order for hops of the plurality of frequency hopped SRS transmissions.

FIG. 19 is a flow chart illustrating an example process 1900 for a wireless communication system in accordance with some aspects of the present disclosure. As described below, some or all illustrated features may be omitted in a particular implementation within the scope of the present disclosure, and some illustrated features may not be required for implementation of all embodiments. In some examples, the process 1900 may be carried out by the UE 1700 illustrated in FIG. 17. In some examples, the process 1900 may be carried out by any suitable apparatus or means for carrying out the functions or algorithm described below.

At block 1902, a UE may receive at least one first sounding reference signal (SRS) configuration. For example, the SRS configuration circuitry 1742 together with the communication and processing circuitry 1741 and the transceiver 1710, shown and described above in connection with FIG. 17, may monitor a designated downlink channel (e.g., a PDCCH or a PDSCH) from a gNB and decode signals received on the channel to identify information (e.g., a DCI, a MAC-CE, or an RRC configuration) directed to the UE.

At block 1904, the UE may determine from the at least one first SRS configuration a first bandwidth for a first SRS frequency hop of a plurality of frequency hopped SRS transmissions. For example, the SRS configuration circuitry 1742 may process the configuration received at block 1906 to determine an SRS hopping bandwidth indicated by an SRS configuration.

At block 1906, the UE may receive a second SRS configuration. For example, the SRS configuration circuitry 1742 together with the communication and processing circuitry 1741 and the transceiver 1710, shown and described above in connection with FIG. 17, may monitor a designated downlink channel (e.g., a PDCCH or a PDSCH) from a gNB and decode signals received on the channel to identify information (e.g., a DCI, a MAC-CE, or an RRC configuration) directed to the UE.

In some examples, receiving the second SRS configuration may include receiving a medium access control-control element (MAC-CE) that includes the second SRS configuration, receiving a downlink control information (DCI) that includes the second SRS configuration, or receiving a radio resource control (RRC) message that includes the second SRS configuration.

At block 1908, the UE may determine from the second SRS configuration that less than all of a plurality of resource blocks associated with the first bandwidth for the first SRS frequency hop are to be used to transmit a first SRS. For example, the SRS configuration circuitry 1742 may process (e.g. parse) a message received at block 1906 to determine whether the message implicitly or explicitly indicates that the UE is to use partial frequency sounding.

At block 1910, the UE may generate the first SRS. For example, the SRS processing circuitry 1743, shown and described above in connection with FIG. 17, may generate an SRS sequence for each hop by cyclic shifting a base sequence (e.g., a Zadoff-Chu sequence). In some examples, the generation of the SRS may depend on the number of RBs in which the SRS will be transmitted.

At block 1912, the UE may transmit the first SRS to a base station via at least one first resource block of the plurality of resource blocks associated with the first bandwidth for the first SRS frequency hop, wherein the at least one first resource block is less than all of the plurality of resource blocks associated with the first bandwidth for the first SRS frequency hop. For example, the SRS processing circuitry 1743 together with the communication and processing circuitry 1741 and the transceiver 1710 may identify, for each hop with an SRS bandwidth, the specific RB(s) to be used for an SRS transmission. In some examples, the same RB(s) will be used for each hop. In some examples (e.g., where cycling is employed), different RBs will be used for different hops. Then, for each hop, the SRS processing circuitry 1743 together with the communication and processing circuitry 1741 and the transceiver 1710 may transmit on the appropriate RB(s) the SRS generated at block 1910 for that hop.

In some examples, the method may further include determining an SRS bandwidth from the at least one first SRS configuration. In some examples, a sum of a plurality of second bandwidths, including the first bandwidth, over the plurality of frequency hopped SRS transmissions, including the first SRS frequency hop, corresponds to the SRS bandwidth.

In some examples, the method may further include determining from the at least one first SRS configuration a second bandwidth for a second SRS frequency hop of the plurality of frequency hopped SRS transmissions, determining from the second SRS configuration that less than all of a plurality of resource blocks associated with the second bandwidth for the second SRS frequency hop are to be used to transmit a second SRS, generating the second SRS, and transmitting the second SRS to the base station via at least one second resource block of the plurality of resource blocks associated with the second bandwidth for the second SRS frequency hop, wherein the at least one second resource block is less than all of the plurality of resource blocks associated with the second bandwidth for the second SRS frequency hop.

In some examples, the second SRS configuration further specifies a location of the at least one first resource block within the plurality of resource blocks. In some examples, the at least one first resource block may include at least two resource blocks and the second SRS configuration further specifies locations of the at least two resource blocks within the plurality of resource blocks.

In some examples, the second SRS configuration may include a bit map, a first bit of the bit map is mapped to a first subset of the plurality of resource blocks, and a second bit of the bit map is mapped to a second subset of the plurality of resource blocks. In some examples, the method may further include determining that the first bit is set and transmitting the first SRS on the first subset of the plurality of resource blocks after determining that the first bit is set.

In some examples, the plurality of resource blocks may include a first set of resource blocks of a plurality of sets of resource blocks designated for the plurality of frequency hopped SRS transmissions. In some examples, the second SRS configuration may include an index indicating at least one resource block location for each set of the plurality of sets of resource blocks, and the method further may include transmitting each hop of the plurality of frequency hopped SRS transmissions at the at least one resource block location for a corresponding set of the plurality of sets of resource blocks.

In some examples, the second SRS configuration specifies a cycling of resource blocks to be used for different hops of the plurality of frequency hopped SRS transmissions. In some examples, the cycling is indicated by a first bit map for the first SRS frequency hop, and a second bit map for a second SRS frequency hop of the plurality of frequency hopped SRS transmissions. In some examples, the cycling may include a shift of a resource block location. In some examples, each set of the plurality of sets of resource blocks may include a first resource block position and a second resource block position and the cycling of resource blocks indicates that a first SRS transmission for the first SRS frequency hop occurs at the first resource block position and a second SRS transmission for a second SRS frequency hop of the plurality of frequency hopped SRS transmissions occurs at the second resource block position.

In some examples, the second SRS configuration further specifies whether the cycling is to be applied to a particular hop of the plurality of frequency hopped SRS transmissions. In some examples, the second SRS configuration may include a bit map that specifies whether the cycling is to be applied to a plurality of resource block positions.

In some examples, the second SRS configuration specifies whether SRS transmission is activated or deactivated for a hop of the plurality of frequency hopped SRS transmissions. In some examples, the second SRS configuration may include a bit map that has a first bit that specifies whether SRS transmission is activated or deactivated for the first SRS frequency hop and a second bit that specifies whether SRS transmission is activated or deactivated for a second SRS frequency hop of the plurality of frequency hopped SRS transmissions.

In some examples, the second SRS configuration specifies a range of resource blocks for the at least one first resource block. In some examples, the second SRS configuration specifies a starting resource block and a quantity of resource blocks for the at least one first resource block.

In some examples, receiving the second SRS configuration may include receiving a downlink control information (DCI) format 0_1 that includes the second SRS configuration. In some examples, receiving the second SRS configuration may include receiving a downlink control information (DCI) that does not schedule a data transmission and includes repurposed bits that carry the second SRS configuration.

In some examples, receiving the second SRS configuration may include receiving a downlink control information (DCI), the DCI specifies a first SRS resource set and a second SRS resource set, the first SRS resource set is associated with a first trigger list, the second SRS resource set is associated with a second trigger list, the first trigger list indicates whether the first SRS is transmitted on less than all of a plurality of resource blocks of the first SRS resource set, and the second trigger list indicates whether a second SRS is transmitted on less than all of a plurality of resource blocks of the second SRS resource set. In some examples, the method may further include receiving a radio resource control (RRC) message that identifies at least one resource of the first SRS resource set that is designated for transmission of the first SRS.

In some examples, the second SRS configuration may include a bit map that identifies at least one resource of the first SRS resource set that is designated for transmission of the first SRS. In some examples, the second SRS configuration further may include a first bit map that identifies at least one resource of the first SRS resource set that is designated for transmission of the first SRS, and a second bit map that identifies at least one resource of the second SRS resource set that is designated for transmission of the second SRS.

In some examples, receiving the second SRS configuration may include receiving a downlink control information (DCI) or a radio resource control (RRC) configuration, and the DCI or the RRC configuration may include a bit that indicates that less than all of the plurality of resource blocks are to be used to transmit the first SRS. In some examples, the method may further include randomly selecting the at least one first resource block. In some examples, randomly selecting the at least one first resource block is based on a scrambling identifier for the user equipment. In some examples, the method may further include selecting the at least one first resource block according to a defined order for hops of the plurality of frequency hopped SRS transmissions.

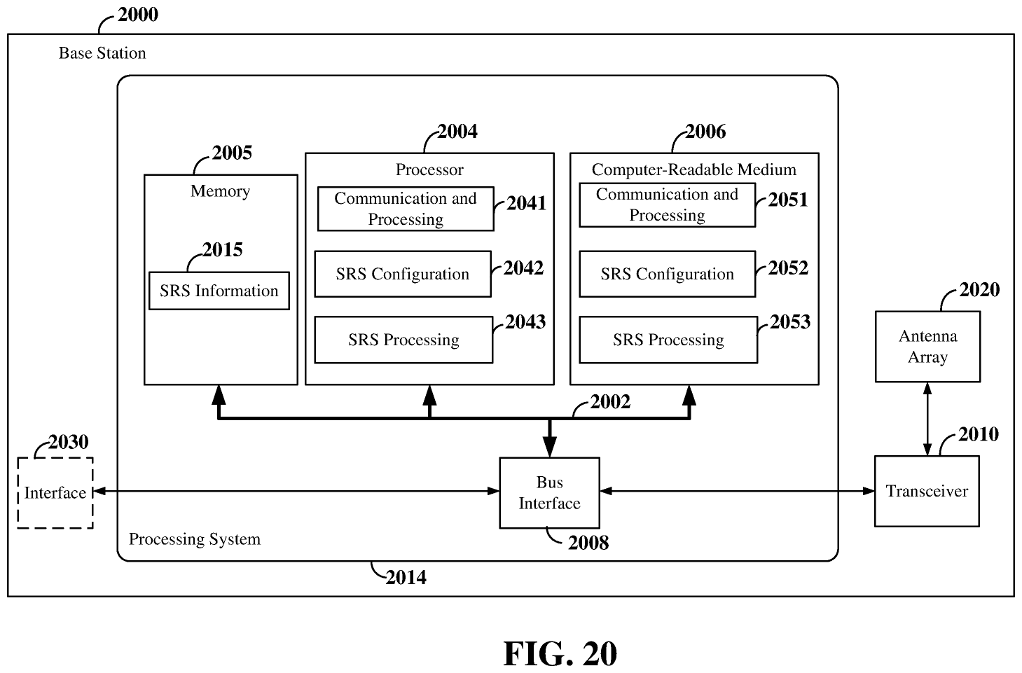

FIG. 20 is a conceptual diagram illustrating an example of a hardware implementation for base station (BS) 2000 employing a processing system 2014. In some implementations, the BS 2000 may correspond to any of the BSs (e.g., gNBs) or scheduling entities shown in any of FIGS. 1, 2, 5-9, 12-15, and 16.

In accordance with various aspects of the disclosure, an element, or any portion of an element, or any combination of elements may be implemented with the processing system 2014. The processing system may include one or more processors 2004. The processing system 2014 may be substantially the same as the processing system 1714 illustrated in FIG. 17, including a bus interface 2008, a bus 2002, memory 2005, a processor 2004, and a computer-readable medium 2006. Furthermore, the BS 2000 may include an interface 2030 (e.g., a network interface) that provides a means for communicating with at least one other apparatus within a core network and with at least one radio access network.

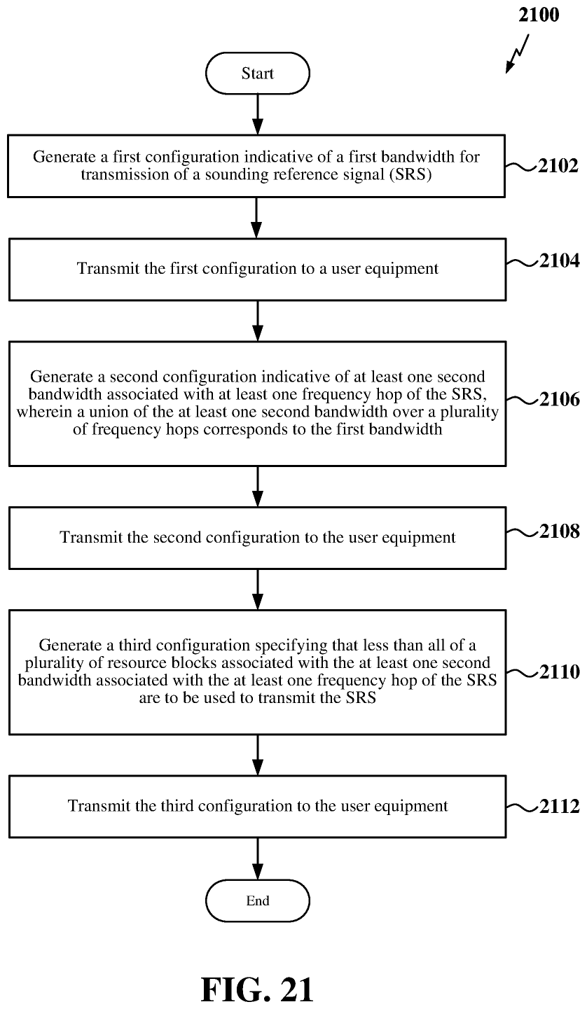

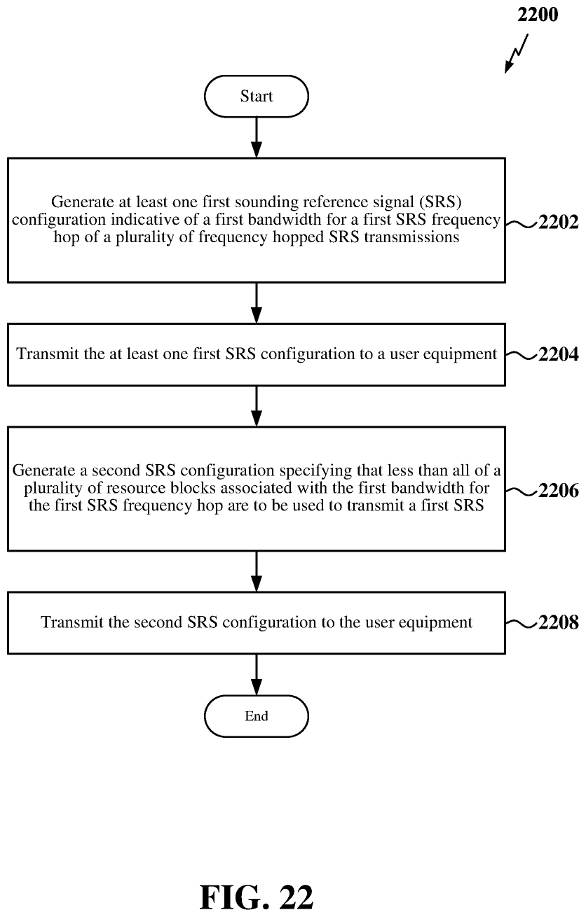

The BS 2000 may be configured to perform any one or more of the operations described herein (e.g., as described above in conjunction with FIGS. 1-16 and as described below in conjunction with FIGS. 21 and 22). In some aspects of the disclosure, the processor 2004, as utilized in the BS 2000, may include circuitry configured for various functions.

The processor 2004 may be configured to generate, schedule, and modify a resource assignment or grant of time-frequency resources (e.g., a set of one or more resource elements). For example, the processor 2004 may schedule time-frequency resources within a plurality of time division duplex (TDD) and/or frequency division duplex (FDD) subframes, slots, and/or mini-slots to carry user data traffic and/or control information to and/or from multiple UEs.

The processor 2004 may be configured to schedule resources for the transmission of downlink reference signals (e.g., SSBs or CSI-RSs) on a plurality of downlink beams for a downlink beam sweep in accordance with a selected downlink beam sweep type and selected number of downlink reference signal resources indicated in a request for uplink beam refinement received from a UE. The processor 2004 may further be configured to schedule resources for the uplink transmission of uplink reference signals (e.g., SRSs) on a plurality of uplink beams for an uplink beam sweep in accordance with a selected beam sweep type and selected number of uplink reference signal resources indicated in the request. The processor 2004 may further be configured to schedule resources that may be utilized by the UE to transmit the request. For example, the uplink beam refinement request resources may include resources scheduled for transmission of a PUCCH, PUSCH, PRACH occasion or RRC message. In some examples, the processor 2004 may be configured to schedule PUSCH resources for the uplink beam refinement request in response to receiving a scheduling request from the UE.

The processor 2004 may further be configured to schedule resources for the transmission of an uplink signal. In some examples, the resources may be associated with one or more uplink transmit beams and one or more corresponding receive beams applied to the uplink signal (e.g., based on the uplink BPLs) based on an indication of the uplink signal associated with the one or more uplink transmit beams included in the request. In some examples, the resources may be associated with an uplink transmission scheme indicating a number of uplink transmit beams to be utilized for the uplink signal, a number of repetitions per uplink transmit beam of the uplink signal, and a multiplexing scheme when more than one uplink transmit beam is used to transmit the uplink signal.

In some aspects of the disclosure, the processor 2004 may include communication and processing circuitry 2041. The communication and processing circuitry 2044 may be configured to communicate with a UE. The communication and processing circuitry 2041 may include one or more hardware components that provide the physical structure that performs various processes related to communication (e.g., signal reception and/or signal transmission) as described herein. The communication and processing circuitry 2041 may further include one or more hardware components that provide the physical structure that performs various processes related to signal processing (e.g., processing a received signal and/or processing a signal for transmission) as described herein. The communication and processing circuitry 2041 may further be configured to execute communication and processing software 2051 included on the computer-readable medium 2006 to implement one or more functions described herein.

In some examples, the communication and processing circuitry 2041 may be configured to receive and process uplink beamformed signals at a mmWave frequency or a sub-6 GHz frequency via the transceiver 2010 and an antenna array 2020. For example, the communication and processing circuitry 2041 may be configured to receive a respective reference signal (e.g., SRS or DMRS) on each of a plurality of uplink beams from the UE during an uplink beam sweep.

In some examples, the communication and processing circuitry 2041 may further be configured to generate and transmit downlink beamformed signals at a mmWave frequency or a sub-6 GHz frequency via the transceiver 2010 and the antenna array 2020. For example, the communication and processing circuitry 2041 may be configured to transmit a respective downlink reference signal (e.g., SSB or CSI-RS) on each of a plurality of downlink beams to the UE during a downlink beam sweep via at least one first antenna panel of the antenna array 2020. The communication and processing circuitry 2041 may further be configured to receive a beam measurement report from the UE.

The communication and processing circuitry 2041 may further be configured to receive a request from the UE. For example, the request may be included in a MAC-CE carried in a PUSCH, UCI in a PUCCH or PUSCH, a random access message, or an RRC message. The communication and processing circuitry 2041 may further be configured to receive a scheduling request (e.g., via UCI in a PUCCH) from the UE for an uplink grant for the PUSCH carrying the MAC-CE including the request for uplink beam refinement.

The communication and processing circuitry 2041 may further be configured to receive an uplink signal on one or more uplink receive beams via one or more uplink transmit beams applied to the uplink signal. For example, the communication and processing circuitry 2041 may be configured to receive the uplink signal on one or more uplink receive beams via at least one second antenna panel of the antenna array 2020. The uplink signal may include, for example, a PUCCH, PUSCH, SRS, DMRS, or PRACH.

The communication and processing circuitry 2041 may further be configured to control the antenna array 2020 and transceiver 2010 to generate a plurality of downlink transmit beams during a downlink beam sweep. The communication and processing circuitry 2041 may further be configured to receive a beam measurement report from the UE using the communication and processing circuitry 2044. The communication and processing circuitry 2041 may further be configured to identify one or more selected uplink beam(s) based on the beam measurements. In some examples, the communication and processing circuitry 2041 may be configured to compare the respective RSRP (or other beam measurement) measured on each of the downlink receive beams for each of the serving downlink transmit beams to identify the serving downlink receive beams and to further identify the serving downlink receive beams as the selected uplink transmit beams. Each serving downlink receive beam may have the highest measured RSRP (or other beam measurement) for one of the downlink transmit beams.

The communication and processing circuitry 2041 may be configured to receive one or more uplink transmit beams in an uplink beam sweep. Each uplink transmit beam may carry an uplink reference signal (e.g., an SRS) for measurement by the communication and processing circuitry 2041. The communication and processing circuitry 2041 may further be configured to obtain a plurality of beam measurements on each of a plurality of uplink receive beams of the antenna array 2020 for each of the uplink transmit beams. The communication and processing circuitry 2041 may further be configured to select the selected uplink transmit beam(s) and corresponding uplink receive beams forming respective uplink BPLs based on the uplink beam measurements.

In some implementations wherein the communication involves receiving information, the communication and processing circuitry 2041 may obtain information from a component of the BS 2000 (e.g., from the transceiver 2010 that receives the information via radio frequency signaling or some other type of signaling suitable for the applicable communication medium), process (e.g., decode) the information, and output the processed information. For example, the communication and processing circuitry 2041 may output the information to another component of the processor 2004, to the memory 2005, or to the bus interface 2008. In some examples, the communication and processing circuitry 2041 may receive one or more of signals, messages, other information, or any combination thereof. In some examples, the communication and processing circuitry 2041 may receive information via one or more channels. In some examples, the communication and processing circuitry 2041 may include functionality for a means for receiving. In some examples, the communication and processing circuitry 2041 may include functionality for a means for decoding.

In some implementations wherein the communication involves sending (e.g., transmitting) information, the communication and processing circuitry 2041 may obtain information (e.g., from another component of the processor 2004, the memory 2005, or the bus interface 2008), process (e.g., encode) the information, and output the processed information. For example, the communication and processing circuitry 2041 may output the information to the transceiver 2010 (e.g., that transmits the information via radio frequency signaling or some other type of signaling suitable for the applicable communication medium). In some examples, the communication and processing circuitry 2041 may send one or more of signals, messages, other information, or any combination thereof. In some examples, the communication and processing circuitry 2041 may send information via one or more channels. In some examples, the communication and processing circuitry 2041 may include functionality for a means for sending (e.g., a means for transmitting). In some examples, the communication and processing circuitry 2041 may include functionality for a means for encoding.

The processor 2004 may include SRS configuration circuitry 2042 configured to perform SRS configuration-related operations as discussed herein (e.g., one or more of the operations described in conjunction with FIGS. 7-16). The SRS configuration circuitry 2042 may include functionality for a means for generating a configuration (e.g., as described at step 1406, 1410 and/or 1412 of FIG. 14, step 1506, 1510, and/or 1512 of FIG. 15, step 1606, 1608, and/or 1610 of FIG. 16, at block 2102, 2106, and/or 2110 of FIG. 21, and/or block 2202 and/or 2206 of FIG. 22). The SRS configuration circuitry 2042 may include functionality for a means for transmitting a configuration (e.g., as described at step 1406, 1410, and/or 1412 of FIG. 14, step 1506, 1510, and/or 1512 of FIG. 15, step 1606, 1608, and/or 1610 of FIG. 16, at block 2104, 2108, and/or 2112 of FIG. 21, and/or at block 2204 and/or 2208 of FIG. 22). The SRS configuration circuitry 2042 may further be configured to execute SRS configuration software 2052 included on the computer-readable medium 2006 to implement one or more functions described herein.

The processor 2004 may include SRS processing circuitry 2043 configured to perform SRS processing-related operations as discussed herein (e.g., one or more of the operations described in conjunction with FIGS. 7-16). The SRS processing circuitry 2043 may include functionality for a means for receiving an SRS. For example, the SRS processing circuitry 2043 may monitor SRS resources at RB locations corresponding to a designated subset of RBs for partial frequency sounding. The SRS processing circuitry 2043 may the decode the energy received on those resource to recover the SRS. The SRS processing circuitry 2043 may include functionality for a means for generating a channel estimate based on a SRS. For example, the SRS processing circuitry 2043 may compare the received SRS with the known original SRS transmitted by the UE. The SRS processing circuitry 2043 may then generate the channel estimate based on any differences between the received SRS and the known original SRS. The SRS processing circuitry 2043 may further be configured to execute SRS processing software 2053 included on the computer-readable medium 2006 to implement one or more functions described herein.

FIG. 21 is a flow chart illustrating an example process 2100 for wireless communication in accordance with some aspects of the present disclosure. As described below, some or all illustrated features may be omitted in a particular implementation within the scope of the present disclosure, and some illustrated features may not be required for implementation of all embodiments. In some examples, the process 2100 may be carried out by the BS 2000 illustrated in FIG. 20. In some examples, the process 2100 may be carried out by any suitable apparatus or means for carrying out the functions or algorithm described below.

At block 2102, a BS may generate a first configuration indicative of a first bandwidth for transmission of a sounding reference signal (SRS). For example, the SRS configuration circuitry 2042, shown and described above in connection with FIG. 20, may allocate one or more SRS resource sets for a UE and select an SCS configuration (e.g., indicative of a particular SRS bandwidth) for the UE to use for SRS transmissions.

At block 2104, the BS may transmit the first configuration to a user equipment. For example, the SRS configuration circuitry 2042 together with the communication and processing circuitry 2041 and the transceiver 2010, shown and described above in connection with FIG. 20, may encode a message or other information (e.g., a DCI, a MAC-CE, or an RRC configuration) from block 2102 for transmission. The SRS configuration circuitry 2042 together with the communication and processing circuitry 2041 and the transceiver 2010 may then transmit the information to the UE on a designated downlink channel (e.g., a PDCCH or a PDSCH).

At block 2106, the BS may generate a second configuration indicative of at least one second bandwidth associated with at least one frequency hop of the SRS, wherein a union of the at least one second bandwidth over a plurality of frequency hops corresponds to the first bandwidth. For example, the SRS configuration circuitry 2042, shown and described above in connection with FIG. 20, may schedule a UE for frequency hopped SRS transmissions and select an SCS configuration (e.g., indicative of a particular SRS hopping bandwidth) for the UE to use for the SRS transmissions.

At block 2108, the BS may transmit the second configuration to the user equipment. For example, the SRS configuration circuitry 2042 together with the communication and processing circuitry 2041 and the transceiver 2010, shown and described above in connection with FIG. 20, may encode a message or other information (e.g., a DCI, a MAC-CE, or an RRC configuration) from block 2106 for transmission. The SRS configuration circuitry 2042 together with the communication and processing circuitry 2041 and the transceiver 2010 may then transmit the information to the UE on a designated downlink channel (e.g., a PDCCH or a PDSCH).

At block 2110, the BS may generate a third configuration specifying that less than all of a plurality of resource blocks associated with the at least one second bandwidth associated with the at least one frequency hop of the SRS are to be used to transmit the SRS. For example, the SRS configuration circuitry 2042, shown and described above in connection with FIG. 20, may determine that increased SRS capacity is needed and/or that the channel to a UE is sufficiently constant to enable SRS interpolation as discussed herein. The SRS configuration circuitry 2042 may then generate a message or other information (e.g., a DCI, a MAC-CE, or an RRC configuration) that implicitly or explicitly indicates that the UE is to use partial frequency sounding. In some examples, the third configuration may explicitly indicate which RBs the UE is to use for each hop.

At block 2112, the BS may transmit the third configuration to the user equipment. For example, the SRS configuration circuitry 2042 together with the communication and processing circuitry 2041 and the transceiver 2010, shown and described above in connection with FIG. 20, may encode the message or other information (e.g., a DCI, a MAC-CE, or an RRC configuration) from block 2110 for transmission. The SRS configuration circuitry 2042 together with the communication and processing circuitry 2041 and the transceiver 2010 may then transmit the information to the UE on a designated downlink channel (e.g., a PDCCH or a PDSCH).

In some examples, transmitting the third configuration may include transmitting a medium access control-control element (MAC-CE) that includes the third configuration, transmitting a downlink control information (DCI) that includes the third configuration, or transmitting a radio resource control (RRC) message that includes the third configuration.

In some examples, the method may further include electing to generate the third configuration to increase SRS signaling capacity.

In some examples, the method may further include specifying a quantity of bits for the third configuration to indicate which group of a plurality of groups of resource blocks is to be used to transmit the SRS. In some examples, the method may further include specifying a quantity of resource blocks associated with each bit of the quantity of bits.

In some examples, the third configuration further specifies a location of at least one resource block within the plurality of resource blocks for transmitting the SRS associated with the at least one second bandwidth associated with the at least one frequency hop of the SRS. In some examples, the at least one resource block may include at least two resource blocks, and the third configuration further specifies locations of the at least two resource blocks within the plurality of resource blocks.

In some examples, the third configuration may include a bit map where: a first bit of the bit map is mapped to a first subset of the plurality of resource blocks, and a second bit of the bit map is mapped to a second subset of the plurality of resource blocks. In some examples, the method may further include setting the first bit, and receiving the SRS on the first subset of the plurality of resource blocks after setting the first bit.

In some examples, the at least one frequency hop comprises a plurality of frequency hopped SRS transmissions. In some examples, the plurality of resource blocks may include a first set of resource blocks of a plurality of sets of resource blocks designated for a plurality of frequency hopped SRS transmissions. In some examples, the third configuration may include an index indicating at least one resource block location for each set of the plurality of sets of resource blocks, and the method further may include receiving the plurality of frequency hopped SRS transmissions on resource blocks at the at least one resource block location for each set of the plurality of sets of resource blocks.

In some examples, the third configuration further specifies a cycling of resource blocks to be used for different hops of the plurality of frequency hopped SRS transmissions. In some examples, the cycling may be indicated by a first bit map for a first hop of the plurality of frequency hopped SRS transmissions, and a second bit map for a second hop of the plurality of frequency hopped SRS transmissions. In some examples, the cycling may include a shift of a resource block location. In some examples, each set of the plurality of sets of resource blocks may include a first resource block position and a second resource block position, and the cycling of resource blocks indicates that a first SRS transmission for a first hop occurs at the first resource block position and a second SRS transmission for a second hop occurs at the second resource block position. In some examples, the third configuration further specifies whether the cycling is to be applied to a particular hop of the plurality of frequency hopped SRS transmissions. In some examples, the third configuration may include a bit map that specifies whether the cycling is to be applied to a plurality of resource block positions.

In some examples, the third configuration further specifies whether SRS transmission is activated or deactivated for a hop of the plurality of frequency hopped SRS transmissions. In some examples, the third configuration further may include a bit map that includes a first bit that specifies whether SRS transmission is activated or deactivated for a first hop of the plurality of frequency hopped SRS transmissions, and a second bit that specifies whether SRS transmission is activated or deactivated for a second hop of the plurality of frequency hopped SRS transmissions.

In some examples, the third configuration further specifies a range of resource blocks to be used to transmit the SRS. In some examples, the third configuration further specifies a starting resource block and a quantity of resource blocks to be used to transmit the SRS.

In some examples, transmitting the third configuration may include transmitting a downlink control information (DCI) format 0_1 that includes the third configuration. In some examples, transmitting the third configuration may include transmitting a downlink control information (DCI) that does not schedule a data transmission and includes repurposed bits that carry the third configuration.

In some examples, transmitting the third configuration may include transmitting a downlink control information (DCI), the DCI specifies a first SRS resource set and a second SRS resource set, the first SRS resource set is associated with a first trigger list, the second SRS resource set is associated with a second trigger list, the first trigger list indicates whether a first SRS is transmitted on less than all of a plurality of resource blocks of the first SRS resource set, and the second trigger list indicates whether a second SRS is transmitted on less than all of a plurality of resource blocks of the second SRS resource set. In some examples, the method may further include transmitting a radio resource control (RRC) message that identifies at least one resource of the first SRS resource set that is designated for transmission of the first SRS. In some examples, the third configuration may include a bit map that identifies at least one resource of the first SRS resource set that is designated for transmission of the first SRS. In some examples, the third configuration further may include a first bit map that identifies at least one resource of the first SRS resource set that is designated for transmission of the first SRS, and a second bit map that identifies at least one resource of the second SRS resource set that is designated for transmission of the second SRS.

In some examples, transmitting the third configuration may include transmitting a downlink control information (DCI) or a radio resource control (RRC) configuration, and the DCI or the RRC configuration may include a bit that indicates that less than all of the plurality of resource blocks designated for the transmission of the SRS are to be used to transmit the SRS. In some examples, the method may further include randomly selecting at least one resource block for receiving the SRS. In some examples, randomly selecting the at least one resource block is based on a scrambling identifier for the user equipment. In some examples, the method may further include selecting at least one resource block for receiving the SRS according to a defined order for hops of the plurality of frequency hopped SRS transmissions.

FIG. 22 is a flow chart illustrating an example process 2200 for wireless communication in accordance with some aspects of the present disclosure. As described below, some or all illustrated features may be omitted in a particular implementation within the scope of the present disclosure, and some illustrated features may not be required for implementation of all embodiments. In some examples, the process 2200 may be carried out by the BS 2000 illustrated in FIG. 20. In some examples, the process 2200 may be carried out by any suitable apparatus or means for carrying out the functions or algorithm described below.

At block 2102, a BS may generate at least one first sounding reference signal (SRS) configuration indicative of a first bandwidth for a first SRS frequency hop of a plurality of frequency hopped SRS transmissions. For example, the SRS configuration circuitry 2042, shown and described above in connection with FIG. 20, may allocate one or more SRS resource sets for a UE. In addition, the SRS configuration circuitry 2042 may schedule the UE for frequency hopped SRS transmissions and select an SCS configuration (e.g., indicative of a particular SRS hopping bandwidth) for the UE to use for the SRS transmissions.

At block 2204, the BS may transmit the at least one first SRS configuration to a user equipment. For example, the SRS configuration circuitry 2042 together with the communication and processing circuitry 2041 and the transceiver 2010, shown and described above in connection with FIG. 20, may encode a message or other information (e.g., a DCI, a MAC-CE, or an RRC configuration) from block 2202 for transmission. The SRS configuration circuitry 2042 together with the communication and processing circuitry 2041 and the transceiver 2010 may then transmit the information to the UE on a designated downlink channel (e.g., a PDCCH or a PDSCH).

At block 2206, the BS may generate second SRS configuration specifying that less than all of a plurality of resource blocks associated with the first bandwidth for the first SRS frequency hop are to be used to transmit a first SRS. For example, the SRS configuration circuitry 2042, shown and described above in connection with FIG. 20, may determine that increased SRS capacity is needed and/or that the channel to a UE is sufficiently constant to enable SRS interpolation as discussed herein. The SRS configuration circuitry 2042 may then generate a message or other information (e.g., a DCI, a MAC-CE, or an RRC configuration) that implicitly or explicitly indicates that the UE is to use partial frequency sounding. In some examples, the second SRS configuration may explicitly indicate which RBs the UE is to use for each hop.

At block 2208, the BS may transmit the second SRS configuration to the user equipment. For example, the SRS configuration circuitry 2042 together with the communication and processing circuitry 2041 and the transceiver 2010, shown and described above in connection with FIG. 20, may encode the message or other information (e.g., a DCI, a MAC-CE, or an RRC configuration) from block 2206 for transmission. The SRS configuration circuitry 2042 together with the communication and processing circuitry 2041 and the transceiver 2010 may then transmit the information to the UE on a designated downlink channel (e.g., a PDCCH or a PDSCH).

In some examples, transmitting the second SRS configuration may include transmitting a medium access control-control element (MAC-CE) that includes the second SRS configuration, transmitting a downlink control information (DCI) that includes the second SRS configuration, or transmitting a radio resource control (RRC) message that includes the second SRS configuration.

In some examples, the at least one first SRS configuration is further indicative of an SRS bandwidth. In some examples, a sum of a plurality of second bandwidths, including the first bandwidth, over the plurality of frequency hopped SRS transmissions, including the first SRS frequency hop, corresponds to the SRS bandwidth.

In some examples, the at least one first SRS configuration is indicative of a second bandwidth for a second SRS frequency hop of the plurality of frequency hopped SRS transmissions, and the second SRS configuration further specifies that less than all of a plurality of resource blocks associated with the second bandwidth for the second SRS frequency hop are to be used to transmit a second SRS.

In some examples, the method may further include electing to generate the second SRS configuration to increase SRS signaling capacity.

In some examples, the method may further include specifying a quantity of bits for the second SRS configuration to indicate which group of a plurality of groups of resource blocks is to be used to transmit the first SRS. In some examples, the method may further include specifying a quantity of resource blocks associated with each bit of the quantity of bits.

In some examples, the second SRS configuration further specifies a location of at least one resource block within the plurality of resource blocks for transmitting the first SRS. In some examples, the at least one resource block may include at least two resource blocks and the second SRS configuration further specifies locations of the at least two resource blocks within the plurality of resource blocks.

In some examples, the second SRS configuration may include a bit map, a first bit of the bit map is mapped to a first subset of the plurality of resource blocks, and a second bit of the bit map is mapped to a second subset of the plurality of resource blocks. In some examples, the method may further include setting the first bit, and receiving the first SRS on the first subset of the plurality of resource blocks after setting the first bit.

In some examples, the plurality of resource blocks may include a first set of resource blocks of a plurality of sets of resource blocks designated for the plurality of frequency hopped SRS transmissions. In some examples, the second SRS configuration may include an index indicating at least one resource block location for each set of the plurality of sets of resource blocks, and the method further may include receiving each hop of the plurality of frequency hopped SRS transmissions at the at least one resource block location for a corresponding set of the plurality of sets of resource blocks.

In some examples, the second SRS configuration further specifies a cycling of resource blocks to be used for different hops of the plurality of frequency hopped SRS transmissions. In some examples, the cycling is indicated by a first bit map for the first SRS frequency hop and a second bit map for a second SRS frequency hop of the plurality of frequency hopped SRS transmissions. In some examples, the cycling may include a shift of a resource block location. In some examples, each set of the plurality of sets of resource blocks may include a first resource block position and a second resource block position, and the cycling of resource blocks indicates that a first SRS transmission for the first SRS frequency hop occurs at the first resource block position and a second SRS transmission for a second SRS frequency hop of the plurality of frequency hopped SRS transmissions occurs at the second resource block position.

In some examples, the second SRS configuration further specifies whether the cycling is to be applied to a particular hop of the plurality of frequency hopped SRS transmissions. In some examples, the second SRS configuration may include a bit map that specifies whether the cycling is to be applied to a plurality of resource block positions.

In some examples, the second SRS configuration further specifies whether SRS transmission is activated or deactivated for a hop of the plurality of frequency hopped SRS transmissions. In some examples, the second SRS configuration further may include a bit map may include a first bit that specifies whether SRS transmission is activated or deactivated for the first SRS frequency hop, and a second bit that specifies whether SRS transmission is activated or deactivated for a second SRS frequency hop of the plurality of frequency hopped SRS transmissions.

In some examples, the second SRS configuration further specifies a range of resource blocks to be used to transmit the first SRS. In some examples, the second SRS configuration further specifies a starting resource block and a quantity of resource blocks to be used to transmit the first SRS.

In some examples, transmitting the second SRS configuration may include transmitting a downlink control information (DCI) format 0_1 that includes the second SRS configuration. In some examples, transmitting the second SRS configuration may include transmitting a downlink control information (DCI) that does not schedule a data transmission and includes repurposed bits that carry the second SRS configuration.

In some examples, transmitting the second SRS configuration may include transmitting a downlink control information (DCI), the DCI specifies a first SRS resource set and a second SRS resource set, the first SRS resource set is associated with a first trigger list; the second SRS resource set is associated with a second trigger list, the first trigger list indicates whether the first SRS is transmitted on less than all of a plurality of resource blocks of the first SRS resource set, and the second trigger list indicates whether a second SRS is transmitted on less than all of a plurality of resource blocks of the second SRS resource set. In some examples, the method may further include transmitting a radio resource control (RRC) message that identifies at least one resource of the first SRS resource set that is designated for transmission of the first SRS. In some examples, the second SRS configuration may include a bit map that identifies at least one resource of the first SRS resource set that is designated for transmission of the first SRS. In some examples, the second SRS configuration further may include a first bit map that identifies at least one resource of the first SRS resource set that is designated for transmission of the first SRS, and a second bit map that identifies at least one resource of the second SRS resource set that is designated for transmission of the second SRS.

In some examples, transmitting the second SRS configuration may include transmitting a downlink control information (DCI) or a radio resource control (RRC) configuration. In some examples, the DCI or the RRC configuration may include a bit that indicates that less than all of the plurality of resource blocks are to be used to transmit the first SRS.

In some examples, the method may further include randomly selecting at least one resource block of the plurality of resource blocks for receiving the first SRS. In some examples, randomly selecting the at least one resource block is based on a scrambling identifier for the user equipment. In some examples, the method may further include selecting at least one resource block of the plurality of resource blocks for receiving the first SRS according to a defined order for hops of the plurality of frequency hopped SRS transmissions.

In some examples, a first method of wireless communication at a user equipment includes: receiving a first configuration; determining from the first configuration a first bandwidth for transmission of a sounding reference signal (SRS); receiving a second configuration; determining from the second configuration at least one second bandwidth associated with at least one frequency hop of the SRS, wherein a union of the at least one second bandwidth over a plurality of frequency hops corresponds to the first bandwidth; receiving a third configuration; determining from the third configuration that less than all of a plurality of resource blocks associated with the at least one second bandwidth associated with the at least one frequency hop of the SRS are to be used to transmit the SRS; generating the SRS; and transmitting the SRS to a base station in each frequency hop of the at least one frequency hop via at least one resource block of the plurality of resource blocks, wherein the at least one resource block is less than all of the plurality of resource blocks associated with the at least one second bandwidth associated with the at least one frequency hop of the SRS. In some examples, a first user equipment includes a transceiver; a memory; and a processor communicatively coupled to the transceiver and the memory. In some examples, the processor and the memory are configured to: receive a first configuration via the transceiver; determine from the first configuration a first bandwidth for transmission of a sounding reference signal (SRS); receive a second configuration via the transceiver; determine from the second configuration at least one second bandwidth associated with at least one frequency hop of the SRS, wherein a union of the at least one second bandwidth over a plurality of frequency hops corresponds to the first bandwidth; receive a third configuration via the transceiver; determine from the third configuration that less than all of a plurality of resource blocks associated with the at least one second bandwidth associated with the at least one frequency hop of the SRS are to be used to transmit the SRS; generate the SRS; and transmit the SRS via the transceiver to a base station in each frequency hop of the at least one frequency hop via at least one resource block of the plurality of resource blocks, wherein the at least one resource block is less than all of the plurality of resource blocks associated with the at least one second bandwidth associated with the at least one frequency hop of the SRS. In some examples, a second user equipment includes: means for receiving a first configuration; means for determining from the first configuration a first bandwidth for transmission of a sounding reference signal (SRS); means for receiving a second configuration; means for determining from the second configuration at least one second bandwidth associated with at least one frequency hop of the SRS, wherein a union of the at least one second bandwidth over a plurality of frequency hops corresponds to the first bandwidth; means for receiving a third configuration; means for determining from the third configuration that less than all of a plurality of resource blocks associated with the at least one second bandwidth associated with the at least one frequency hop of the SRS are to be used to transmit the SRS; means for generating the SRS; and means for transmitting the SRS to a base station in each frequency hop of the at least one frequency hop via at least one resource block of the plurality of resource blocks, wherein the at least one resource block is less than all of the plurality of resource blocks associated with the at least one second bandwidth associated with the at least one frequency hop of the SRS. In some examples, a first article of manufacture for use by a user equipment in a wireless communication network includes a computer-readable medium having stored therein instructions executable by one or more processors of the user equipment to: receive a first configuration; determine from the first configuration a first bandwidth for transmission of a sounding reference signal (SRS); receive a second configuration; determine from the second configuration at least one second bandwidth associated with at least one frequency hop of the SRS, wherein a union of the at least one second bandwidth over a plurality of frequency hops corresponds to the first bandwidth; receive a third configuration; determine from the third configuration that less than all of a plurality of resource blocks associated with the at least one second bandwidth associated with the at least one frequency hop of the SRS are to be used to transmit the SRS; generate the SRS; and transmit the SRS to a base station in each frequency hop of the at least one frequency hop via at least one resource block of the plurality of resource blocks, wherein the at least one resource block is less than all of the plurality of resource blocks associated with the at least one second bandwidth associated with the at least one frequency hop of the SRS.

In some examples, any one of the first method, the first user equipment, the second user equipment, the first article of manufacture, or a combination thereof may include any one of or any combination of the following features: 1) receiving the third configuration comprises: receiving a medium access control-control element (MAC-CE) that includes the third configuration, receiving a downlink control information (DCI) that includes the third configuration, or receiving a radio resource control (RRC) message that includes the third configuration; 2) the third configuration further specifies a location of the at least one resource block within the plurality of resource blocks associated with the at least one second bandwidth associated with the at least one frequency hop of the SRS; 3) the at least one resource block comprises at least two resource blocks; and the third configuration further specifies locations of the at least two resource blocks within the plurality of resource blocks; 4) the third configuration comprises a bit map; a first bit of the bit map is mapped to a first subset of the plurality of resource blocks; and a second bit of the bit map is mapped to a second subset of the plurality of resource blocks; 5) determining that a first bit is set; and transmitting the SRS on a first subset of the plurality of resource blocks after determining that the first bit is set; 6) the at least one frequency hop comprises a plurality of frequency hopped SRS transmissions; and the plurality of resource blocks comprises a first set of resource blocks of a plurality of sets of resource blocks designated for the plurality of frequency hopped SRS transmissions; 7) the third configuration comprises an index indicating at least one resource block location for each set of a plurality of sets of resource blocks; and transmitting a plurality of frequency hopped SRS transmissions at the at least one resource block location for each set of the plurality of sets of resource blocks; 8) the third configuration specifies a cycling of resource blocks to be used for different hops of a plurality of frequency hopped SRS transmissions; 9) the cycling is indicated by: a first bit map for a first hop of the plurality of frequency hopped SRS transmissions; and a second bit map for a second hop of the plurality of frequency hopped SRS transmissions; 10) the cycling comprises a shift of a resource block location; 11) each set of a plurality of sets of resource blocks comprises a first resource block position and a second resource block position; and cycling of resource blocks indicates that a first SRS transmission for a first hop occurs at the first resource block position and a second SRS transmission for a second hop occurs at the second resource block position; 12) the third configuration further specifies whether cycling is to be applied to a particular hop of the plurality of frequency hopped SRS transmissions; 13) the third configuration comprises a bit map that specifies whether cycling is to be applied to a plurality of resource block positions; 14) the third configuration specifies whether SRS transmission is activated or deactivated for a hop of a plurality of frequency hopped SRS transmissions; 15) the third configuration comprises a bit map comprising: a first bit that specifies whether SRS transmission is activated or deactivated for a first hop of a plurality of frequency hopped SRS transmissions; and a second bit that specifies whether SRS transmission is activated or deactivated for a second hop of the plurality of frequency hopped SRS transmissions; 16) the third configuration specifies a range of resource blocks for the at least one resource block; 17) the third configuration specifies a starting resource block and a quantity of resource blocks for the at least one resource block; 18) receiving the third configuration comprises: receiving a downlink control information (DCI) format 0_1 that includes the third configuration; 19) receiving the third configuration comprises: receiving a downlink control information (DCI) that does not schedule a data transmission and includes repurposed bits comprising the third configuration; 20) receiving the third configuration comprises receiving a downlink control information (DCI); the DCI specifies a first SRS resource set and a second SRS resource set; the first SRS resource set is associated with a first trigger list; the second SRS resource set is associated with a second trigger list; the first trigger list indicates whether a first SRS is transmitted on less than all of a plurality of resource blocks of the first SRS resource set; and the second trigger list indicates whether a second SRS is transmitted on less than all of a plurality of resource blocks of the second SRS resource set; 21) receiving a radio resource control (RRC) message that identifies at least one resource of a first SRS resource set that is designated for transmission a the first SRS; 22) the third configuration comprises a bit map that identifies at least one resource of a first SRS resource set that is designated for transmission of a first SRS; 23) the third configuration further comprises: a first bit map that identifies at least one resource of a first SRS resource set that is designated for transmission of a first SRS; and a second bit map that identifies at least one resource of a second SRS resource set that is designated for transmission of a second SRS; 24) receiving the third configuration comprises receiving a downlink control information (DCI) or a radio resource control (RRC) configuration; and the DCI or the RRC configuration comprises a bit that indicates that less than all of the plurality of resource blocks are to be used to transmit the SRS; 25) randomly selecting the at least one resource block; 26) randomly selecting the at least one resource block is based on a scrambling identifier for the user equipment; 27) selecting the at least one resource block according to a defined order for hops of a plurality of frequency hopped SRS transmissions.

In some examples, a second method of wireless communication at a base station includes: generating a first configuration indicative of a first bandwidth for transmission of a sounding reference signal (SRS); transmitting the first configuration to a user equipment; generating a second configuration indicative of at least one second bandwidth associated with at least one frequency hop of the SRS, wherein a union of the at least one second bandwidth over a plurality of frequency hops corresponds to the first bandwidth; transmitting the second configuration to the user equipment; generating a third configuration specifying that less than all of a plurality of resource blocks associated with the at least one second bandwidth associated with the at least one frequency hop of the SRS are to be used to transmit the SRS; and transmitting the third configuration to the user equipment. In some examples, a first base station includes a transceiver; a memory; and a processor communicatively coupled to the transceiver and the memory. In some examples, the processor and the memory are configured to: generate a first configuration indicative of a first bandwidth for transmission of a sounding reference signal (SRS); transmit the first configuration to a user equipment via the transceiver; generate a second configuration indicative of at least one second bandwidth associated with at least one frequency hop of the SRS, wherein a union of the at least one second bandwidth over a plurality of frequency hops corresponds to the first bandwidth; transmit the second configuration to the user equipment via the transceiver; generate a third configuration specifying that less than all of a plurality of resource blocks associated with the at least one second bandwidth associated with the at least one frequency hop of the SRS are to be used to transmit the SRS; and transmit the third configuration to the user equipment via the transceiver. In some examples, a second base station includes: means for generating a first configuration indicative of a first bandwidth for transmission of a sounding reference signal (SRS); means for transmitting the first configuration to a user equipment; means for generating a second configuration indicative of at least one second bandwidth associated with at least one frequency hop of the SRS, wherein a union of the at least one second bandwidth over a plurality of frequency hops corresponds to the first bandwidth; means for transmitting the second configuration to the user equipment; means for generating a third configuration specifying that less than all of a plurality of resource blocks associated with the at least one second bandwidth associated with the at least one frequency hop of the SRS are to be used to transmit the SRS; and means for transmitting the third configuration to the user equipment. In some examples, a second article of manufacture for use by a base station in a wireless communication network includes a computer-readable medium having stored therein instructions executable by one or more processors of the base station to: generate a first configuration indicative of a first bandwidth for transmission of a sounding reference signal (SRS); transmit the first configuration to a user equipment; generate a second configuration indicative of at least one second bandwidth associated with at least one frequency hop of the SRS, wherein a union of the at least one second bandwidth over a plurality of frequency hops corresponds to the first bandwidth; transmit the second configuration to the user equipment; generate a third configuration specifying that less than all of a plurality of resource blocks associated with the at least one second bandwidth associated with the at least one frequency hop of the SRS are to be used to transmit the SRS; and transmit the third configuration to the user equipment.

In some examples, any one of the second method, the first base station, the second base station, the second article of manufacture, or a combination thereof may include any one of or any combination of the following features: 1) electing to generate the third configuration to increase SRS signaling capacity; 2) specifying a quantity of bits for the third configuration to indicate which group of a plurality of groups of resource blocks is to be used to transmit the SRS; 3) specifying a quantity of resource blocks associated with each bit of a quantity of bits; 4) transmitting the third configuration comprises: transmitting a medium access control-control element (MAC-CE) that includes the third configuration, transmitting a downlink control information (DCI) that includes the third configuration, or transmitting a radio resource control (RRC) message that includes the third configuration; 5) the third configuration further specifies a location of at least one resource block within the plurality of resource blocks associated with the at least one second bandwidth associated with the at least one frequency hop of the SRS; 6) the third configuration further specifies locations of at least two resource blocks within the plurality of resource blocks; 7) the third configuration comprises a bit map; a first bit of the bit map is mapped to a first subset of the plurality of resource blocks; and a second bit of the bit map is mapped to a second subset of the plurality of resource blocks; 8) setting a first bit; and receiving the SRS on a first subset of the plurality of resource blocks after setting the first bit; 9) the at least one frequency hop comprises a plurality of frequency hopped SRS transmissions; and the plurality of resource blocks comprises a first set of resource blocks of a plurality of sets of resource blocks designated for the plurality of frequency hopped SRS transmissions; 10) the third configuration comprises an index indicating at least one resource block location for each set of a plurality of sets of resource blocks; and the method further comprises receiving a plurality of frequency hopped SRS transmissions at the at least one resource block location for each set of the plurality of sets of resource blocks; 11) the third configuration further specifies a cycling of resource blocks to be used for different hops of a plurality of frequency hopped SRS transmissions; 12) cycling is indicated by: a first bit map for a first hop of a plurality of frequency hopped SRS transmissions; and a second bit map for a second hop of the plurality of frequency hopped SRS transmissions; 13) cycling comprises a shift of a resource block location; 14) each set of a plurality of sets of resource blocks comprises a first resource block position and a second resource block position; and cycling of resource blocks indicates that a first SRS transmission for a first hop occurs at the first resource block position and a second SRS transmission for a second hop occurs at the second resource block position; 15) the third configuration further specifies whether cycling is to be applied to a particular hop of a plurality of frequency hopped SRS transmissions; 16) the third configuration comprises a bit map that specifies whether cycling is to be applied to a plurality of resource block positions; 17) the third configuration further specifies whether SRS transmission is activated or deactivated for a hop of a plurality of frequency hopped SRS transmissions; 18) the third configuration further comprises a bit map comprising: a first bit that specifies whether SRS transmission is activated or deactivated for a first hop of a plurality of frequency hopped SRS transmissions; and a second bit that specifies whether SRS transmission is activated or deactivated for a second hop of the plurality of frequency hopped SRS transmissions; 19) the third configuration further specifies a range of resource blocks to be used to transmit the SRS; 20) the third configuration further specifies a starting resource block and a quantity of resource blocks to be used to transmit the SRS; 21) transmitting the third configuration comprises: transmitting a downlink control information (DCI) format 0_1 that includes the third configuration; 22) transmitting the third configuration comprises: transmitting a downlink control information (DCI) that does not schedule a data transmission and includes repurposed bits comprising the third configuration; 23) transmitting the third configuration comprises transmitting a downlink control information (DCI); the DCI specifies a first SRS resource set and a second SRS resource set; the first SRS resource set is associated with a first trigger list; the second SRS resource set is associated with a second trigger list; the first trigger list indicates whether a first SRS is transmitted on less than all of a plurality of resource blocks of the first SRS resource set; and the second trigger list indicates whether a second SRS is transmitted on less than all of a plurality of resource blocks of the second SRS resource set; 24) transmitting a radio resource control (RRC) message that identifies at least one resource of a first SRS resource set that is designated for transmission of a first SRS; 25) the third configuration comprises a bit map that identifies at least one resource of a first SRS resource set that is designated for transmission of a first SRS; 26) the third configuration further comprises: a first bit map that identifies at least one resource of a first SRS resource set that is designated for transmission of a first SRS; and a second bit map that identifies at least one resource of a second SRS resource set that is designated for transmission of a second SRS; 27) transmitting the third configuration comprises transmitting a downlink control information (DCI) or a radio resource control (RRC) configuration; and the DCI or the RRC configuration comprises a bit that indicates that less than all of the plurality of resource blocks are to be used to transmit the SRS; 28) randomly selecting at least one resource block for receiving the SRS; 29) randomly selecting the at least one resource block based on a scrambling identifier for the user equipment; 30) selecting at least one resource block for receiving the SRS according to a defined order for hops of a plurality of frequency hopped SRS transmissions.

In some examples, a third method of wireless communication at a user equipment includes: receiving at least one first sounding reference signal (SRS) configuration; determining from the at least one first SRS configuration a first bandwidth for a first SRS frequency hop of a plurality of frequency hopped SRS transmissions; receiving a second SRS configuration; determining from the second SRS configuration that less than all of a plurality of resource blocks associated with the first bandwidth for the first SRS frequency hop are to be used to transmit a first SRS; generating the first SRS; and transmitting the first SRS to a base station via at least one first resource block of the plurality of resource blocks associated with the first bandwidth for the first SRS frequency hop, wherein the at least one first resource block is less than all of the plurality of resource blocks associated with the first bandwidth for the first SRS frequency hop. In some examples, a third user equipment includes a transceiver; a memory; and a processor communicatively coupled to the transceiver and the memory. In some examples, the processor and the memory are configured to: receive at least one first sounding reference signal (SRS) configuration via the transceiver; determine from the at least one first SRS configuration a first bandwidth for a first SRS frequency hop of a plurality of frequency hopped SRS transmissions; receive a second SRS configuration via the transceiver; determine from the second SRS configuration that less than all of a plurality of resource blocks associated with the first bandwidth for the first SRS frequency hop are to be used to transmit a first SRS; generate the first SRS; and transmit the first SRS via the transceiver to a base station via at least one first resource block of the plurality of resource blocks associated with the first bandwidth for the first SRS frequency hop, wherein the at least one first resource block is less than all of the plurality of resource blocks associated with the first bandwidth for the first SRS frequency hop. In some examples, a fourth user equipment includes: means for receiving at least one first sounding reference signal (SRS) configuration; means for determining from the at least one first SRS configuration a first bandwidth for a first SRS frequency hop of a plurality of frequency hopped SRS transmissions; means for receiving a second SRS configuration; means for determining from the second SRS configuration that less than all of a plurality of resource blocks associated with the first bandwidth for the first SRS frequency hop are to be used to transmit a first SRS; means for generating the first SRS; and means for transmitting the first SRS to a base station via at least one first resource block of the plurality of resource blocks associated with the first bandwidth for the first SRS frequency hop, wherein the at least one first resource block is less than all of the plurality of resource blocks associated with the first bandwidth for the first SRS frequency hop. In some examples, a third article of manufacture for use by a user equipment in a wireless communication network includes a computer-readable medium having stored therein instructions executable by one or more processors of the user equipment to: receive at least one first sounding reference signal (SRS) configuration; determine from the at least one first SRS configuration a first bandwidth for a first SRS frequency hop of a plurality of frequency hopped SRS transmissions; receive a second SRS configuration; determine from the second SRS configuration that less than all of a plurality of resource blocks associated with the first bandwidth for the first SRS frequency hop are to be used to transmit a first SRS; generate the first SRS; and transmit the first SRS to a base station via at least one first resource block of the plurality of resource blocks associated with the first bandwidth for the first SRS frequency hop, wherein the at least one first resource block is less than all of the plurality of resource blocks associated with the first bandwidth for the first SRS frequency hop.

In some examples, any one of the third method, the third user equipment, the fourth user equipment, the third article of manufacture, or a combination thereof may include any one of or any combination of the following features: 1) determining an SRS bandwidth from the at least one first SRS configuration; wherein a sum of a plurality of second bandwidths, including the first bandwidth, over the plurality of frequency hopped SRS transmissions, including the first SRS frequency hop, corresponds to the SRS bandwidth; 2) determining from the at least one first SRS configuration a second bandwidth for a second SRS frequency hop of the plurality of frequency hopped SRS transmissions; determining from the second SRS configuration that less than all of a plurality of resource blocks associated with the second bandwidth for the second SRS frequency hop are to be used to transmit a second SRS; generating the second SRS; and transmitting the second SRS to the base station via at least one second resource block of the plurality of resource blocks associated with the second bandwidth for the second SRS frequency hop, wherein the at least one second resource block is less than all of the plurality of resource blocks associated with the second bandwidth for the second SRS frequency hop; 3) receiving the second SRS configuration comprises: receiving a medium access control-control element (MAC-CE) that includes the second SRS configuration, receiving a downlink control information (DCI) that includes the second SRS configuration, or receiving a radio resource control (RRC) message that includes the second SRS configuration; 4) the second SRS configuration further specifies a location of the at least one first resource block within the plurality of resource blocks; 5) the at least one first resource block comprises at least two resource blocks; and the second SRS configuration further specifies locations of the at least two resource blocks within the plurality of resource blocks; 6) the second SRS configuration comprises a bit map; a first bit of the bit map is mapped to a first subset of the plurality of resource blocks; and a second bit of the bit map is mapped to a second subset of the plurality of resource blocks; 7) determining that a first bit is set; and transmitting the first SRS on a first subset of the plurality of resource blocks after determining that the first bit is set; 8) the plurality of resource blocks comprises a first set of resource blocks of a plurality of sets of resource blocks designated for the plurality of frequency hopped SRS transmissions; 9) the second SRS configuration comprises an index indicating at least one resource block location for each set of a plurality of sets of resource blocks; and the method further comprises transmitting each hop of the plurality of frequency hopped SRS transmissions at the at least one resource block location for a corresponding set of the plurality of sets of resource blocks; 10) the second SRS configuration specifies a cycling of resource blocks to be used for different hops of the plurality of frequency hopped SRS transmissions; 11) cycling is indicated by: a first bit map for the first SRS frequency hop; and a second bit map for a second SRS frequency hop of the plurality of frequency hopped SRS transmissions; 12) cycling comprises a shift of a resource block location; 13) each set of a plurality of sets of resource blocks comprises a first resource block position and a second resource block position; and cycling of resource blocks indicates that a first SRS transmission for the first SRS frequency hop occurs at the first resource block position and a second SRS transmission for a second SRS frequency hop of the plurality of frequency hopped SRS transmissions occurs at the second resource block position; 14) the second SRS configuration further specifies whether cycling is to be applied to a particular hop of the plurality of frequency hopped SRS transmissions; 15) the second SRS configuration comprises a bit map that specifies whether cycling is to be applied to a plurality of resource block positions; 16) the second SRS configuration specifies whether SRS transmission is activated or deactivated for a hop of the plurality of frequency hopped SRS transmissions; 17) the second SRS configuration further comprises a bit map comprising: a first bit that specifies whether SRS transmission is activated or deactivated for the first SRS frequency hop; and a second bit that specifies whether SRS transmission is activated or deactivated for a second SRS frequency hop of the plurality of frequency hopped SRS transmissions; 18) the second SRS configuration specifies a range of resource blocks for the at least one first resource block; 19) the second SRS configuration specifies a starting resource block and a quantity of resource blocks for the at least one first resource block; 20) receiving the second SRS configuration comprises: receiving a downlink control information (DCI) format 0_1 that includes the second SRS configuration; 21) receiving the second SRS configuration comprises: receiving a downlink control information (DCI) that does not schedule a data transmission and includes repurposed bits comprising the second SRS configuration; 22) receiving the second SRS configuration comprises receiving a downlink control information (DCI); the DCI specifies a first SRS resource set and a second SRS resource set; the first SRS resource set is associated with a first trigger list; the second SRS resource set is associated with a second trigger list; the first trigger list indicates whether the first SRS is transmitted on less than all of a plurality of resource blocks of the first SRS resource set; and the second trigger list indicates whether a second SRS is transmitted on less than all of a plurality of resource blocks of the second SRS resource set; 23) receiving a radio resource control (RRC) message that identifies at least one resource of a first SRS resource set that is designated for transmission of the first SRS; 24) the second SRS configuration comprises a bit map that identifies at least one resource of a first SRS resource set that is designated for transmission of the first SRS; 25) the second SRS configuration further comprises: a first bit map that identifies at least one resource of a first SRS resource set that is designated for transmission of the first SRS; and a second bit map that identifies at least one resource of a second SRS resource set that is designated for transmission of a second SRS; 26) receiving the second SRS configuration comprises receiving a downlink control information (DCI) or a radio resource control (RRC) configuration; and the DCI or the RRC configuration comprises a bit that indicates that less than all of the plurality of resource blocks are to be used to transmit the first SRS; 27) randomly selecting the at least one first resource block; 28) randomly selecting the at least one first resource block is based on a scrambling identifier for the user equipment; 29) selecting the at least one first resource block according to a defined order for hops of the plurality of frequency hopped SRS transmissions.

In some examples, a fourth method of wireless communication at a base station includes: generating at least one first sounding reference signal (SRS) configuration indicative of a first bandwidth for a first SRS frequency hop of a plurality of frequency hopped SRS transmissions; transmitting the at least one first SRS configuration to a user equipment; generating a second SRS configuration specifying that less than all of a plurality of resource blocks associated with the first bandwidth for the first SRS frequency hop are to be used to transmit a first SRS; and transmitting the second SRS configuration to the user equipment. In some examples, a third base station includes a transceiver; a memory; and a processor communicatively coupled to the transceiver and the memory. In some examples, the processor and the memory are configured to: generate at least one first sounding reference signal (SRS) configuration indicative of a first bandwidth for a first SRS frequency hop of a plurality of frequency hopped SRS transmissions; transmit the at least one first SRS configuration to a user equipment via the transceiver; generate a second SRS configuration specifying that less than all of a plurality of resource blocks associated with the first bandwidth for the first SRS frequency hop are to be used to transmit a first SRS; and transmit the second SRS configuration to the user equipment via the transceiver. In some examples, a fourth base station includes: means for generating at least one first sounding reference signal (SRS) configuration indicative of a first bandwidth for a first SRS frequency hop of a plurality of frequency hopped SRS transmissions; means for transmitting the at least one first SRS configuration to a user equipment; means for generating a second SRS configuration specifying that less than all of a plurality of resource blocks associated with the first bandwidth for the first SRS frequency hop are to be used to transmit a first SRS; and means for transmitting the second SRS configuration to the user equipment. In some examples, a fourth article of manufacture for use by a base station in a wireless communication network includes a computer-readable medium having stored therein instructions executable by one or more processors of the base station to: generate at least one first sounding reference signal (SRS) configuration indicative of a first bandwidth for a first SRS frequency hop of a plurality of frequency hopped SRS transmissions; transmit the at least one first SRS configuration to a user equipment; generate a second SRS configuration specifying that less than all of a plurality of resource blocks associated with the first bandwidth for the first SRS frequency hop are to be used to transmit a first SRS; and transmit the second SRS configuration to the user equipment.

In some examples, any one of the fourth method, the third base station, the fourth base station, the fourth article of manufacture, or a combination thereof may include any one of or any combination of the following features: 1) the at least one first SRS configuration is further indicative of an SRS bandwidth; and a sum of a plurality of second bandwidths, including the first bandwidth, over the plurality of frequency hopped SRS transmissions, including the first SRS frequency hop, corresponds to the SRS bandwidth; 2) the at least one first SRS configuration is indicative of a second bandwidth for a second SRS frequency hop of the plurality of frequency hopped SRS transmissions; and the second SRS configuration further specifies that less than all of a plurality of resource blocks associated with the second bandwidth for the second SRS frequency hop are to be used to transmit a second SRS; 3) electing to generate the second SRS configuration to increase SRS signaling capacity; 4) specifying a quantity of bits for the second SRS configuration to indicate which group of a plurality of groups of resource blocks is to be used to transmit the first SRS; 5) specifying a quantity of resource blocks associated with each bit of a quantity of bits; 6) transmitting a medium access control-control element (MAC-CE) that includes the second SRS configuration, transmitting a downlink control information (DCI) that includes the second SRS configuration, or transmitting a radio resource control (RRC) message that includes the second SRS configuration; 7) the second SRS configuration further specifies a location of at least one resource block within the plurality of resource blocks for transmitting the first SRS; 8) the second SRS configuration further specifies locations of at least two resource blocks within the plurality of resource blocks; 9) the second SRS configuration comprises a bit map; a first bit of the bit map is mapped to a first subset of the plurality of resource blocks; and a second bit of the bit map is mapped to a second subset of the plurality of resource blocks; 10) setting a first bit; and receiving the first SRS on a first subset of the plurality of resource blocks after setting the first bit; 11) the plurality of resource blocks comprises a first set of resource blocks of a plurality of sets of resource blocks designated for the plurality of frequency hopped SRS transmissions; 12) the second SRS configuration comprises an index indicating at least one resource block location for each set of a plurality of sets of resource blocks; and the method further comprises receiving each hop of the plurality of frequency hopped SRS transmissions at the at least one resource block location for a corresponding set of the plurality of sets of resource blocks; 13) the second SRS configuration further specifies a cycling of resource blocks to be used for different hops of the plurality of frequency hopped SRS transmissions; 14) cycling is indicated by: a first bit map for the first SRS frequency hop; and a second bit map for a second SRS frequency hop of the plurality of frequency hopped SRS transmissions; 15) cycling comprises a shift of a resource block location; 16) each set of a plurality of sets of resource blocks comprises a first resource block position and a second resource block position; and cycling of resource blocks indicates that a first SRS transmission for the first SRS frequency hop occurs at the first resource block position and a second SRS transmission for a second SRS frequency hop of the plurality of frequency hopped SRS transmissions occurs at the second resource block position; 17) the second SRS configuration further specifies whether cycling is to be applied to a particular hop of the plurality of frequency hopped SRS transmissions; 18) the second SRS configuration comprises a bit map that specifies whether cycling is to be applied to a plurality of resource block positions; 19) the second SRS configuration further specifies whether SRS transmission is activated or deactivated for a hop of the plurality of frequency hopped SRS transmissions; 20) the second SRS configuration further comprises a bit map comprising: a first bit that specifies whether SRS transmission is activated or deactivated for the first SRS frequency hop; and a second bit that specifies whether SRS transmission is activated or deactivated for a second SRS frequency hop of the plurality of frequency hopped SRS transmissions; 21) the second SRS configuration further specifies a range of resource blocks to be used to transmit the first SRS; 22) the second SRS configuration further specifies a starting resource block and a quantity of resource blocks to be used to transmit the first SRS; 23) transmitting the second SRS configuration comprises: transmitting a downlink control information (DCI) format 0_1 that includes the second SRS configuration; 24) transmitting the second SRS configuration comprises: transmitting a downlink control information (DCI) that does not schedule a data transmission and includes repurposed bits comprising the second SRS configuration; 25) the transmitting the second SRS configuration comprises transmitting a downlink control information (DCI); the DCI specifies a first SRS resource set and a second SRS resource set; the first SRS resource set is associated with a first trigger list; the second SRS resource set is associated with a second trigger list; the first trigger list indicates whether the first SRS is transmitted on less than all of a plurality of resource blocks of the first SRS resource set; and the second trigger list indicates whether a second SRS is transmitted on less than all of a plurality of resource blocks of the second SRS resource set; 26) transmitting a radio resource control (RRC) message that identifies at least one resource of a first SRS resource set that is designated for transmission of the first SRS; 27) the second SRS configuration comprises a bit map that identifies at least one resource of a first SRS resource set that is designated for transmission of the first SRS; 28) the second SRS configuration further comprises: a first bit map that identifies at least one resource of a first SRS resource set that is designated for transmission of the first SRS; and a second bit map that identifies at least one resource of a second SRS resource set that is designated for transmission of a second SRS; 29) transmitting the second SRS configuration comprises transmitting a downlink control information (DCI) or a radio resource control (RRC) configuration; and the DCI or the RRC configuration comprises a bit that indicates that less than all of the plurality of resource blocks are to be used to transmit the first SRS; 30) randomly selecting at least one resource block of the plurality of resource blocks for receiving the first SRS; 31) randomly selecting the at least one resource block is based on a scrambling identifier for the user equipment; 32) selecting at least one resource block of the plurality of resource blocks for receiving the first SRS according to a defined order for hops of the plurality of frequency hopped SRS transmissions.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-22 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in any of FIGS. 1-22 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method of wireless communication at a user equipment, the method comprising:
receiving a first configuration;
determining from the first configuration a first bandwidth for transmission of a sounding reference signal (SRS);
receiving a second configuration;
determining from the second configuration at least one second bandwidth associated with at least one frequency hop of the SRS, wherein a union of the at least one second bandwidth over a plurality of frequency hops corresponds to the first bandwidth;
receiving a third configuration;
determining from the third configuration that less than all of a plurality of resource blocks associated with the at least one second bandwidth associated with the at least one frequency hop of the SRS are to be used to transmit the SRS;
generating the SRS; and
transmitting the SRS to a base station in each frequency hop of the at least one frequency hop via at least one resource block of the plurality of resource blocks, wherein the at least one resource block is less than all of the plurality of resource blocks associated with the at least one second bandwidth associated with the at least one frequency hop of the SRS.

2. The method of claim 1, wherein the receiving the third configuration comprises:
receiving a medium access control-control element (MAC-CE) that includes the third configuration, receiving a downlink control information (DCI) that includes the third configuration, or receiving a radio resource control (RRC) message that includes the third configuration.

3. The method of claim 1, wherein the third configuration further specifies a location of the at least one resource block within the plurality of resource blocks associated with the at least one second bandwidth associated with the at least one frequency hop of the SRS.

4. The method of claim 1, wherein:
the at least one resource block comprises at least two resource blocks; and
the third configuration further specifies locations of the at least two resource blocks within the plurality of resource blocks.

5. The method of claim 1, wherein:
the third configuration comprises a bit map;
a first bit of the bit map is mapped to a first subset of the plurality of resource blocks; and
a second bit of the bit map is mapped to a second subset of the plurality of resource blocks.

6. The method of claim 5, further comprising:
determining that the first bit is set; and
transmitting the SRS on the first subset of the plurality of resource blocks after determining that the first bit is set.

7. The method of claim 1, wherein:
the at least one frequency hop comprises a plurality of frequency hopped SRS transmissions; and
the plurality of resource blocks comprises a first set of resource blocks of a plurality of sets of resource blocks designated for the plurality of frequency hopped SRS transmissions.

8. The method of claim 7, wherein:
the third configuration comprises an index indicating at least one resource block location for each set of the plurality of sets of resource blocks; and
the method further comprises transmitting the plurality of frequency hopped SRS transmissions at the at least one resource block location for each set of the plurality of sets of resource blocks.

9. The method of claim 7, wherein the third configuration specifies a cycling of resource blocks to be used for different hops of the plurality of frequency hopped SRS transmissions.

10. The method of claim 9, wherein the cycling is indicated by:
a first bit map for a first hop of the plurality of frequency hopped SRS transmissions; and
a second bit map for a second hop of the plurality of frequency hopped SRS transmissions.

11. The method of claim 9, wherein the cycling comprises a shift of a resource block location.

12. The method of claim 9, wherein:
each set of the plurality of sets of resource blocks comprises a first resource block position and a second resource block position; and
the cycling of resource blocks indicates that a first SRS transmission for a first hop occurs at the first resource block position and a second SRS transmission for a second hop occurs at the second resource block position.

13. The method of claim 9, wherein the third configuration further specifies whether the cycling is to be applied to a particular hop of the plurality of frequency hopped SRS transmissions.

14. The method of claim 9, wherein the third configuration comprises a bit map that specifies whether the cycling is to be applied to a plurality of resource block positions.

15. The method of claim 7, wherein the third configuration specifies whether SRS transmission is activated or deactivated for a hop of the plurality of frequency hopped SRS transmissions.

16. The method of claim 7, wherein the third configuration comprises a bit map comprising:
a first bit that specifies whether SRS transmission is activated or deactivated for a first hop of the plurality of frequency hopped SRS transmissions; and
a second bit that specifies whether SRS transmission is activated or deactivated for a second hop of the plurality of frequency hopped SRS transmissions.

17. The method of claim 7, wherein the third configuration specifies a range of resource blocks for the at least one resource block.

18. The method of claim 7, wherein the third configuration specifies a starting resource block and a quantity of resource blocks for the at least one resource block.

19. The method of claim 7, wherein the receiving the third configuration comprises:
receiving a downlink control information (DCI) format 0_1 that includes the third configuration.

20. The method of claim 7, wherein the receiving the third configuration comprises:
receiving a downlink control information (DCI) that does not schedule a data transmission and includes repurposed bits comprising the third configuration.

21. The method of claim 7, wherein:
the receiving the third configuration comprises receiving a downlink control information (DCI);
the DCI specifies a first SRS resource set and a second SRS resource set;
the first SRS resource set is associated with a first trigger list;
the second SRS resource set is associated with a second trigger list;
the first trigger list indicates whether a first SRS is transmitted on less than all of a plurality of resource blocks of the first SRS resource set; and
the second trigger list indicates whether a second SRS is transmitted on less than all of a plurality of resource blocks of the second SRS resource set.

22. The method of claim 21, further comprising:
receiving a radio resource control (RRC) message that identifies at least one resource of the first SRS resource set that is designated for transmission of the first SRS.

23. The method of claim 21, wherein the third configuration comprises a bit map that identifies at least one resource of the first SRS resource set that is designated for transmission of the first SRS.

24. The method of claim 21, wherein the third configuration further comprises:
a first bit map that identifies at least one resource of the first SRS resource set that is designated for transmission of the first SRS; and
a second bit map that identifies at least one resource of the second SRS resource set that is designated for transmission of the second SRS.

25. The method of claim 7, wherein:
the receiving the third configuration comprises receiving a downlink control information (DCI) or a radio resource control (RRC) configuration; and
the DCI or the RRC configuration comprises a bit that indicates that less than all of the plurality of resource blocks are to be used to transmit the SRS.

26. The method of claim 25, further comprising:
randomly selecting the at least one resource block.

27. The method of claim 26, wherein the randomly selecting the at least one resource block is based on a scrambling identifier for the user equipment.

28. The method of claim 25, further comprising:
selecting the at least one resource block according to a defined order for hops of the plurality of frequency hopped SRS transmissions.

29. A user equipment, comprising:
a transceiver;
a memory; and
a processor communicatively coupled to the transceiver and the memory, wherein the processor and the memory are configured to:
receive a first configuration via the transceiver;
determine from the first configuration a first bandwidth for transmission of a sounding reference signal (SRS);
receive a second configuration via the transceiver;
determine from the second configuration at least one second bandwidth associated with at least one frequency hop of the SRS, wherein a union of the at least one second bandwidth over a plurality of frequency hops corresponds to the first bandwidth;
receive a third configuration via the transceiver;
determine from the third configuration that less than all of a plurality of resource blocks associated with the at least one second bandwidth associated with the at least one frequency hop of the SRS are to be used to transmit the SRS;
generate the SRS; and
transmit the SRS via the transceiver to a base station in each frequency hop of the at least one frequency hop via at least one resource block of the plurality of resource blocks, wherein the at least one resource block is less than all of the plurality of resource blocks associated with the at least one second bandwidth associated with the at least one frequency hop of the SRS.

30. The user equipment of claim 29, wherein the processor and the memory are further configured to:
receive a medium access control-control element (MAC-CE) that includes the third configuration, receive a downlink control information (DCI) that includes the third configuration, or receive a radio resource control (RRC) message that includes the third configuration.

31. The user equipment of claim 29, wherein the third configuration further specifies a location of the at least one resource block within the plurality of resource blocks associated with the at least one second bandwidth associated with the at least one frequency hop of the SRS.

32. The user equipment of claim 29, wherein:
the at least one resource block comprises at least two resource blocks; and
the third configuration further specifies locations of the at least two resource blocks within the plurality of resource blocks.

33. The user equipment of claim 29, wherein:
the third configuration comprises a bit map;
a first bit of the bit map is mapped to a first subset of the plurality of resource blocks; and
a second bit of the bit map is mapped to a second subset of the plurality of resource blocks.

34. The user equipment of claim 33, wherein the processor and the memory are further configured to:
determine that the first bit is set; and
transmit the SRS on the first subset of the plurality of resource blocks after determining that the first bit is set.

35. The user equipment of claim 29, wherein:
the at least one frequency hop comprises a plurality of frequency hopped SRS transmissions; and
the plurality of resource blocks comprises a first set of resource blocks of a plurality of sets of resource blocks designated for the plurality of frequency hopped SRS transmissions.

36. The user equipment of claim 35, wherein:
the third configuration comprises an index indicating at least one resource block location for each set of the plurality of sets of resource blocks; and
the processor and the memory are further configured to transmit the plurality of frequency hopped SRS transmissions at the at least one resource block location for each set of the plurality of sets of resource blocks.

37. The user equipment of claim 35, wherein the third configuration specifies a cycling of resource blocks to be used for different hops of the plurality of frequency hopped SRS transmissions.

38. The user equipment of claim 37, wherein the cycling is indicated by:
a first bit map for a first hop of the plurality of frequency hopped SRS transmissions; and
a second bit map for a second hop of the plurality of frequency hopped SRS transmissions.

39. The user equipment of claim 37, wherein the cycling comprises a shift of a resource block location.

40. The user equipment of claim 37, wherein:
each set of the plurality of sets of resource blocks comprises a first resource block position and a second resource block position; and
the cycling of resource blocks indicates that a first SRS transmission for a first hop occurs at the first resource block position and a second SRS transmission for a second hop occurs at the second resource block position.

41. The user equipment of claim 37, wherein the third configuration further specifies whether the cycling is to be applied to a particular hop of the plurality of frequency hopped SRS transmissions.

42. The user equipment of claim 37, wherein the third configuration comprises a bit map that specifies whether the cycling is to be applied to a plurality of resource block positions.

43. The user equipment of claim 35, wherein the third configuration specifies whether SRS transmission is activated or deactivated for a hop of the plurality of frequency hopped SRS transmissions.

44. The user equipment of claim 35, wherein the third configuration further comprises a bit map comprising:
a first bit that specifies whether SRS transmission is activated or deactivated for a first hop of the plurality of frequency hopped SRS transmissions; and
a second bit that specifies whether SRS transmission is activated or deactivated for a second hop of the plurality of frequency hopped SRS transmissions.

45. The user equipment of claim 35, wherein the third configuration specifies a range of resource blocks for the at least one resource block.

46. The user equipment of claim 35, wherein the third configuration specifies a starting resource block and a quantity of resource blocks for the at least one resource block.

47. The user equipment of claim 35, wherein the processor and the memory are further configured to:
receive a downlink control information (DCI) format 0_1 that includes the third configuration.

48. The user equipment of claim 35, wherein the processor and the memory are further configured to:
receive a downlink control information (DCI) that does not schedule a data transmission and includes repurposed bits comprising the third configuration.

49. The user equipment of claim 35, wherein:
the processor and the memory are further configured to receive a downlink control information (DCI);
the DCI specifies a first SRS resource set and a second SRS resource set;
the first SRS resource set is associated with a first trigger list;
the second SRS resource set is associated with a second trigger list;
the first trigger list indicates whether a first SRS is transmitted on less than all of a plurality of resource blocks of the first SRS resource set; and
the second trigger list indicates whether a second SRS is transmitted on less than all of a plurality of resource blocks of the second SRS resource set.

50. The user equipment of claim 49, wherein the processor and the memory are further configured to:
receive a radio resource control (RRC) message that identifies at least one resource of the first SRS resource set that is designated for transmission of the first SRS.

51. The user equipment of claim 49, wherein the third configuration comprises a bit map that identifies at least one resource of the first SRS resource set that is designated for transmission of the first SRS.

52. The user equipment of claim 49, wherein the third configuration further comprises:
a first bit map that identifies at least one resource of the first SRS resource set that is designated for transmission of the first SRS; and
a second bit map that identifies at least one resource of the second SRS resource set that is designated for transmission of the second SRS.

53. The user equipment of claim 35, wherein:
the processor and the memory are further configured to receive a downlink control information (DCI) or a radio resource control (RRC) configuration; and
the DCI or the RRC configuration comprises a bit that indicates that less than all of the plurality of resource blocks are to be used to transmit the SRS.

54. The user equipment of claim 53, wherein the processor and the memory are further configured to:
randomly select the at least one resource block.

55. The user equipment of claim 53, wherein the processor and the memory are further configured to:
randomly select the at least one resource block based on a scrambling identifier for the user equipment.

56. The user equipment of claim 53, wherein the processor and the memory are further configured to:
select the at least one resource block according to a defined order for hops of the plurality of frequency hopped SRS transmissions.

57. (canceled)
